(19) United States
(12) Patent Application Publication
(10) Pub. No.: US 2026/0368026 A1
(43) Pub. Date: Nov. 19, 2026

(54) AUTOMATED INCIDENT REMEDIATION USING MACHINE LEARNING

(71) Applicant: International Business Machines Corporation, Armonk, NY (US)

(72) Inventors: Brad Lee BLANCETT, Raleigh, NC (US); Arthur DE MAGALHAES, Markham (CA); Chad HOLLIDAY, Holly Springs, NC (US); Pooja AGGARWAL, Bengaluru (IN); Rong-Sheng LEE, Staatsburg, NY (US); Kavya NEKKALAPU, CARY, NC (US)

(21) Appl. No.: 19/212,640

(22) Filed: May 19, 2025

(51) Int. Cl. G06F 11/07; G06F 16/334

(52) U.S. Cl. CPC G06F 11/0793; G06F 16/334

(57) ABSTRACT

Baseline data indicative of at least one of a metric, an event, a log, or a trace associated with a computing environment in a fault-free state is obtained. A fault is injected into the computing environment to simulate an incident. A set of fault data associated with the fault is obtained. A remediation script is generated based on the fault data using a machine learning component. The remediation script is provided for execution in the computing environment.

### BACKGROUND

The present invention relates to code generation, and for example, relates to automated incident remediation using machine learning.

### SUMMARY

In one embodiment, a computer-implemented method is provided. In this embodiment, the method includes obtaining baseline data indicative of at least one of a metric, an event, a log, or a trace associated with a computing environment in a fault-free state. The method further includes injecting a fault into the computing environment to simulate an incident, obtaining a set of fault data associated with the fault, generating a remediation script based on the fault data using a machine learning component, and providing the remediation script for execution in the computing environment.

In another embodiment, a computer program product is provided. In this embodiment, the computer program product includes one or more computer-readable storage media and program instructions stored on the one or more computer-readable storage media to perform operations. The operations include obtaining baseline data indicative of at least one of a metric, an event, a log, or a trace associated with a computing environment in a fault-free state, injecting a fault into the computing environment to simulate an incident, obtaining a set of fault data associated with the fault, generating a remediation script based on the fault data using a machine learning component, and providing the remediation script for execution in the computing environment.

In yet another embodiment, a computer system is provided. In this embodiment, the computer system includes a processor set, one or more computer-readable storage media, and program instructions stored on the one or more computer-readable storage media to cause the processor set to perform operations. The operations include obtaining baseline data indicative of at least one of a metric, an event, a log, or a trace associated with a computing environment in a fault-free state, injecting a fault into the computing environment to simulate an incident, obtaining a set of fault data associated with the fault, generating a remediation script based on the fault data using a machine learning component, and providing the remediation script for execution in the computing environment.

### BRIEF DESCRIPTION OF THE DRAWINGS

FIG. 1A is a block diagram of an example computing environment described herein.

FIG. 1B is a block diagram of the code manager of FIG. 1A.

FIG. 1C is a data flow diagram of an example associated with a process for automated code evaluation and enhancement implemented by the code manager of FIGS. 1A and 1B.

FIG. 1D is a data flow diagram of an example of the action processing engine of FIG. 1A.

FIG. 1E is a data flow diagram of another example associated with a process for automated code evaluation and enhancement implemented by the code manager of FIG. 1A.

FIG. 1F is a data flow diagram of an example of the semantic validation engine of FIG. 1A.

FIG. 1G is a data flow diagram of an example of the feedback component of FIG. 1A.

FIG. 1H is a block diagram of the remediation manager of FIG. 1A.

FIG. 1I is a data flow diagram of an example associated with a process for automated incident remediation implemented by the remediation manager of FIGS. 1A and 1H.

FIGS. 2A and 2B are schematic diagrams showing examples associated with automated incident remediation described herein.

FIG. 3 is a diagram of an example computing environment in which systems and/or methods described herein may be implemented.

FIG. 4 is a diagram of example components of one or more devices of FIG. 1A.

FIG. 5 is a flowchart of an example technique associated with automated incident remediation described herein.

### DETAILED DESCRIPTION

The following detailed description of example implementations refers to the accompanying drawings. The same reference numbers in different drawings may identify the same or similar elements.

In the realm of software development and system administration, the generation and evaluation of code have become increasingly important tasks. As software systems grow in complexity and scale, there is a need for automated tools that can assist developers and administrators in creating, assessing, and refining code efficiently. Traditional approaches to code generation and evaluation often rely on manual processes or require extensive sets of predefined test cases, which can be time-consuming, error-prone, and limited in their ability to cover diverse scenarios.

Large language models (LLMs) have emerged as powerful tools for generating code based on natural language descriptions. However, the evaluation of LLM-generated code presents technical challenges. Current methods for assessing code correctness typically involve executing the code or comparing it against pre-existing reference solutions. These approaches have inherent limitations, particularly when dealing with non-deterministic tasks, system-dependent operations, or scenarios where ground truth solutions are not readily available. Furthermore, the execution of generated code in isolated environments with proper configurations can be complex and resource-intensive, especially for system administration tasks or operations that interact with specific hardware or network setups.

Current incident management systems often struggle to keep pace with the dynamic nature of modern IT infrastructures. Traditional approaches to incident remediation typically involve manual intervention by system administrators or site reliability engineers (SREs), who must analyze logs, metrics, and system states to identify the source of a problem. This process can be time-consuming, error-prone, and heavily dependent on the expertise of individual team members. Moreover, as systems become more complex, the sheer volume of data generated during an incident can overwhelm human operators, leading to longer mean time to resolution (MTTR) and increased potential for human error.

The lack of automated, intelligent remediation capabilities presents a technical challenge in maintaining system reliability and performance. Many existing tools focus on incident detection and alerting but fall short in providing actionable, context-aware remediation steps. This gap often results in a disconnect between incident identification and resolution, leading to prolonged downtime and increased operational costs. Furthermore, the absence of a systematic approach to capturing and leveraging knowledge from past incidents hampers the ability of organizations to improve their incident response processes over time.

Another issue is the difficulty in simulating and preparing for potential incidents in a controlled environment. Without effective means to inject faults and test remediation strategies, organizations struggle to proactively improve their incident response capabilities. This limitation not only affects the readiness of IT teams to handle real-world incidents but also impedes the development and validation of automated remediation scripts and procedures. In some implementations, organizations find themselves in a reactive posture, addressing incidents as they occur rather than building robust, proactive incident management systems that can anticipate and mitigate potential issues before they escalate into problems.

Implementations of this disclosure address problems such as these by providing systems and methods for automated incident remediation using machine learning techniques. In some implementations, the disclosed approach obtains baseline data indicative of metrics, events, logs, and/or traces associated with a computing environment in a fault-free state. This baseline data serves as a reference point for normal system operation. For example, the baseline data may include CPU utilization percentages, network traffic patterns, application response times, and system log entries during typical operational conditions.

The disclosure introduces a fault injection mechanism to simulate incidents in a controlled manner. In some implementations, a fault may be injected into the computing environment to recreate specific problematic scenarios. For instance, a fault could involve artificially increasing CPU load, introducing network latency, or triggering application errors. This controlled fault injection facilitates proactive testing and improvement of incident response capabilities.

Based on fault injection, the system obtains a set of fault data associated with the simulated incident. This fault data may encompass various aspects of the system's state during the incident, including metrics that deviate from baseline values, newly generated error logs, and changes in application behavior. In some implementations, the fault data may be collected using application performance monitoring (APM) tools, log aggregators, or custom data collection agents deployed within the computing environment.

An aspect of the disclosure involves generating a remediation script using a machine learning component. In some implementations, this machine learning component may be an LLM trained on historical incident data, system documentation, and best practices for incident resolution. The remediation script generation process may take into account the specific fault data collected, as well as contextual information about the affected systems and applications. For example, the machine learning component might analyze CPU spike patterns, correlate them with application logs, and generate a script to identify and terminate resource-intensive processes.

The generated remediation script is then provided for execution in the computing environment. In some implementations, this execution may be performed automatically, while in others, it may require human approval before application. The execution of the remediation script aims to resolve the simulated incident and restore the system to a healthy state. For instance, the script might restart services, adjust configuration parameters, or clear cache to address the injected fault.

After script execution, the system may obtain remediation data corresponding to the post-execution state of the computing environment. This remediation data is then compared to the original baseline data to determine the effectiveness of the remediation script. In some implementations, a remediation score may be calculated based on the similarity between the baseline and remediation data. This score may consider multiple factors, such as the degree of metric restoration, the resolution of logged errors, and the overall system stability post-remediation.

The remediation score serves as a feedback mechanism for improving future incident response. In some implementations, the score may be used to modify the prompts or inputs used by the machine learning component, enhancing its ability to generate more effective remediation scripts over time. This creates a continual learning loop, where each simulated incident and remediation attempt contributes to the system's knowledge base and improves its incident resolution capabilities.

In some implementations, the disclosure may include features such as automated fault type selection based on historical incident patterns, integration with IT service management (ITSM) systems for coordinated incident response, or the use of reinforcement learning techniques to optimize remediation strategies. The system may also be extended to handle multi-step remediation processes, addressing complex incidents that require a sequence of corrective actions across different components of the computing environment.

In some implementations, the system utilizes automated fault type selection based on historical incident patterns. Accordingly, an advantage of the automated fault type selection is improved efficiency in identifying and simulating relevant incidents. Additionally, an advantage of the automated fault type selection is increased accuracy in fault injection, as it leverages past data to target common or critical issues. Furthermore, an advantage of the automated fault type selection is the ability to proactively prepare for a wider range of potential incidents, enhancing overall system resilience.

In some implementations, the system integrates with ITSM systems for coordinated incident response. Accordingly, an advantage of the ITSM integration is streamlined communication between automated remediation processes and human operators. Additionally, an advantage of the ITSM integration is improved tracking and documentation of incident resolution steps, facilitating better auditing and compliance. Moreover, an advantage of the ITSM integration is the ability to leverage existing ITSM workflows and knowledge bases, enhancing the overall effectiveness of the remediation process.

In some implementations, the system employs reinforcement learning techniques to optimize remediation strategies. Accordingly, an advantage of using reinforcement learning is the continuous improvement of remediation scripts over time based on their effectiveness. Additionally, an advantage of using reinforcement learning is the ability to adapt to changing system conditions and evolving incident patterns. Furthermore, an advantage of using reinforcement learning is the potential to discover novel and more efficient remediation approaches that may not be obvious to human operators.

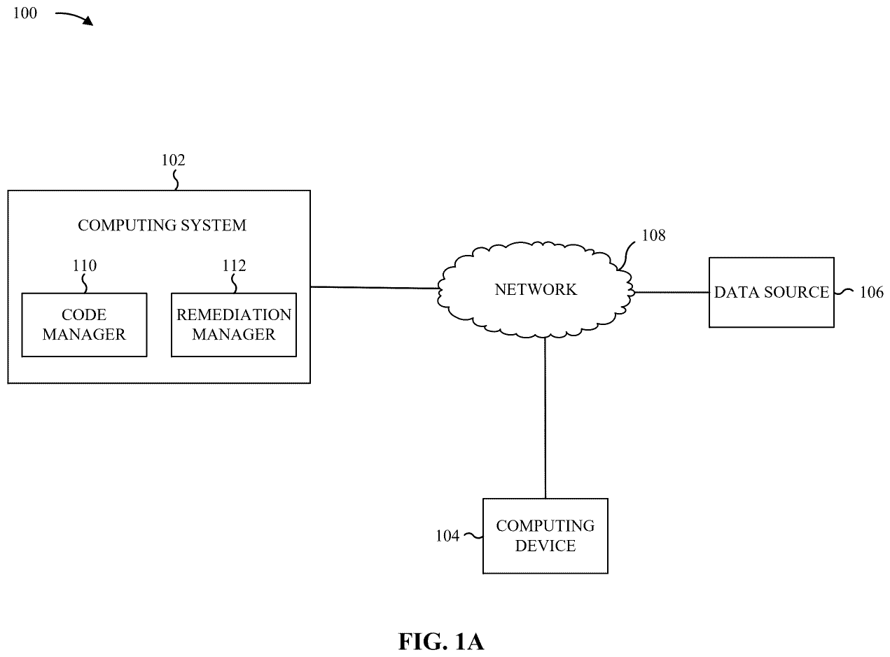

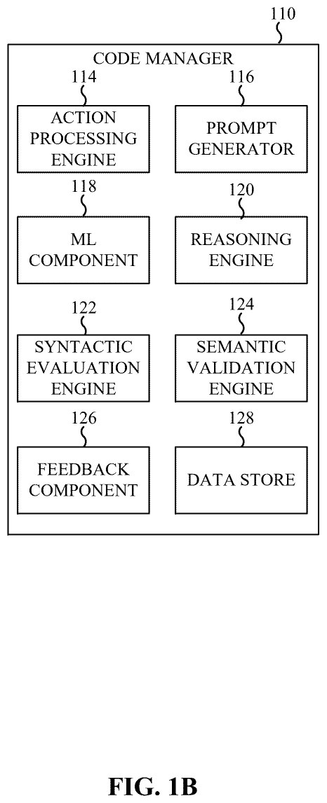

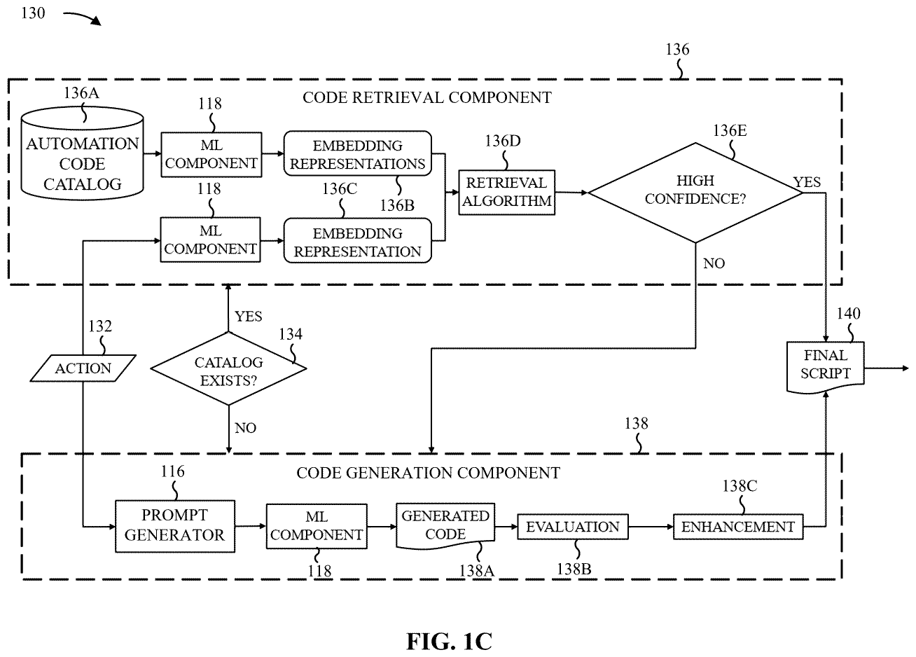

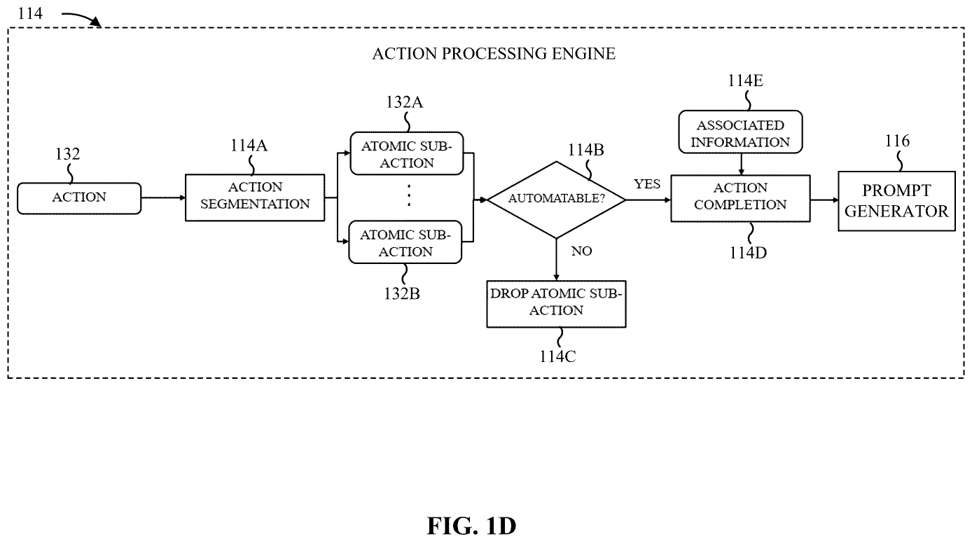

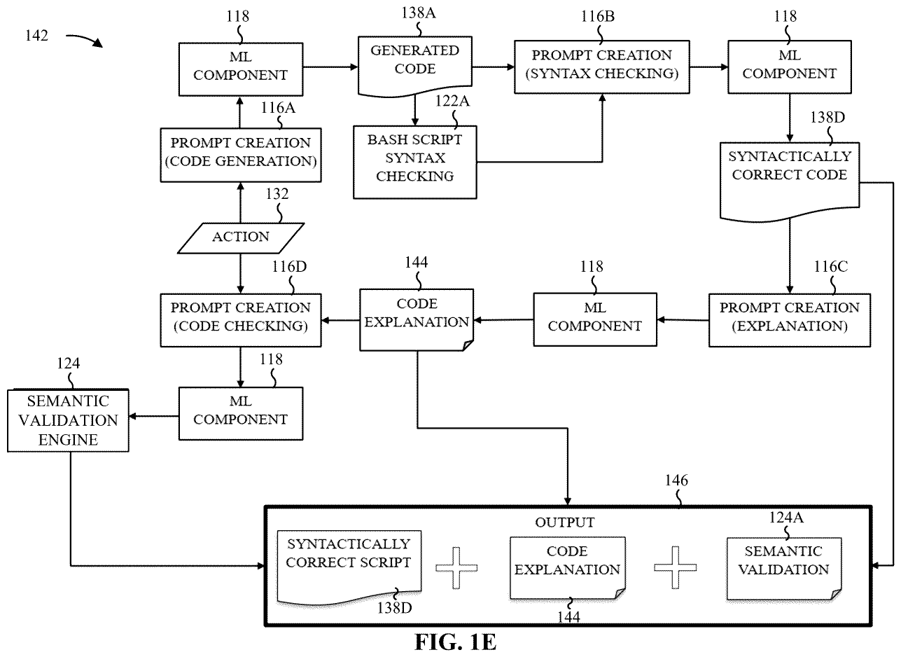

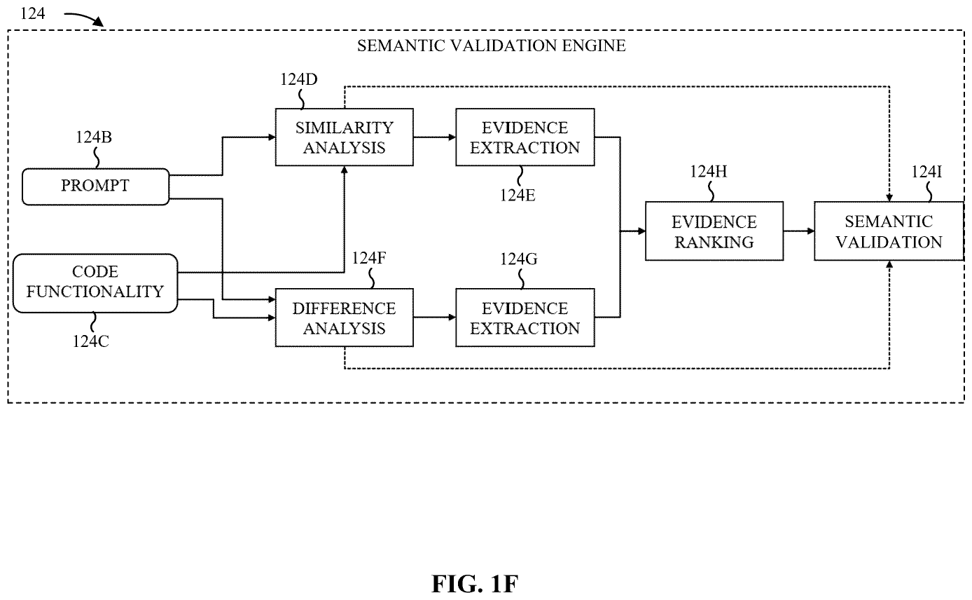

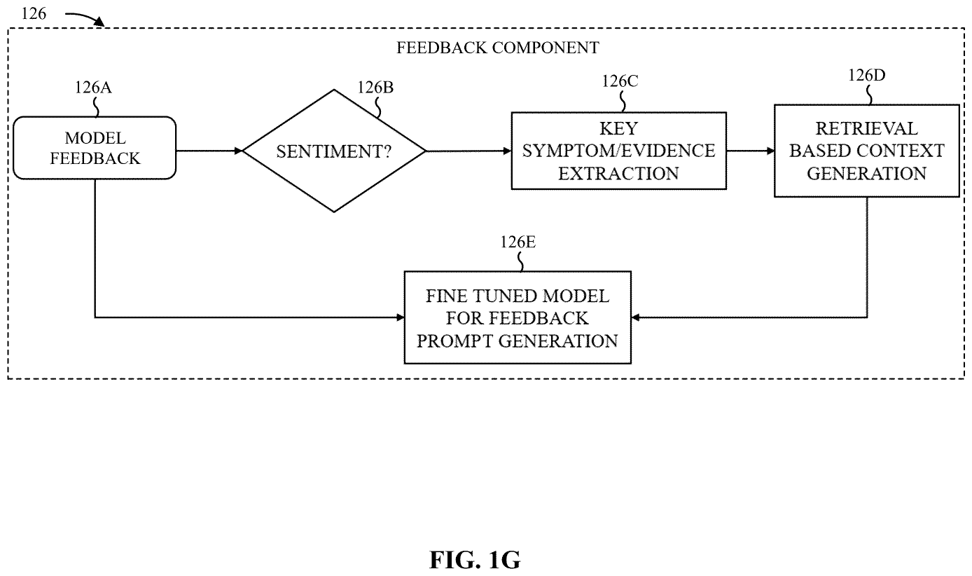

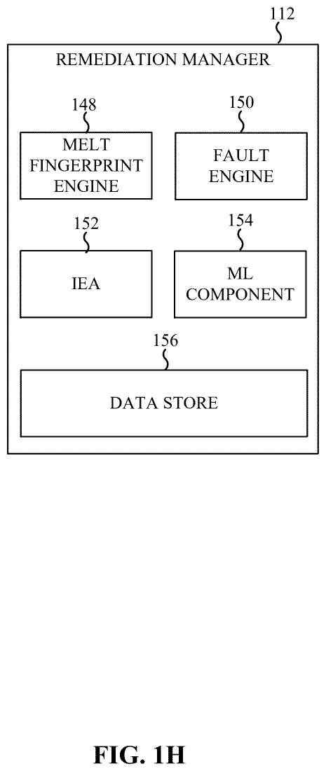

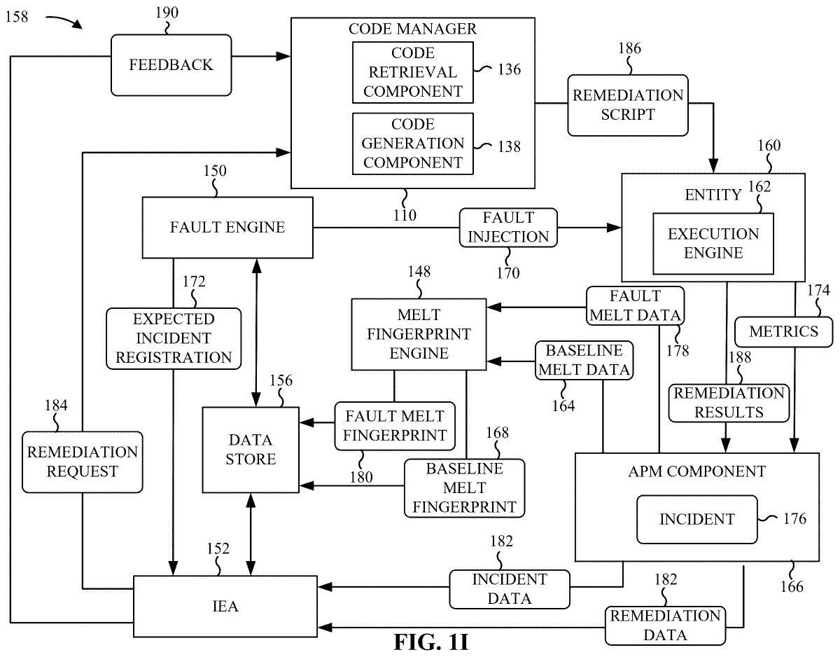

FIG. 1A illustrates a block diagram of an example computing environment 100. As shown, the computing environment 100 includes a computing system 102, a computing device 104, a data source 106, and a network 108 connecting these components. In some implementations, the computing system 102 may be any suitable computing system or environment such as a cloud, a server system, or individual computers or computing devices. For example, the computing system 102 may include one or more servers or computer systems that are remote from an end user device from which code manager may be accessed. In some implementations, the computing device 104 includes a computing device or a collection of computing devices. For example, the computing device 104 may include a computer, a laptop computer, a desktop computer, or a collection of servers or computer systems (e.g., a server farm). In some implementations, the data source 106 may include a data storage or database. In some implementations, computing device 104 and/or the data source 106 may be part of the computing system 102.

The network 108 may include one or more wired and/or wireless networks. For example, the network 108 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

The computing device 104 may interact with the code manager 110 and/or the remediation manager 112 through the network 108 to utilize the code evaluation and generation capabilities. In some implementations, the computing device 104 may serve as an end-user device for submitting code generation requests or receiving evaluation results.

The computing device 104 may be implemented as any number of various types of electronic devices capable of communicating with the code manager 110 and/or the remediation manager 112 through the network 108. These devices may include, but are not limited to, desktop computers, laptop computers, tablets, smartphones, wearable devices, or specialized hardware designed for specific code generation and evaluation tasks. In some implementations, the computing device 104 may be equipped with user interface components such as displays, keyboards, touchscreens, or voice input systems to facilitate user interaction with the computing system 102.

The computing device 104 may run specialized software applications or web-based interfaces that allow users to formulate code generation requests, view evaluation results, and interact with the generated code. These applications may provide features such as syntax highlighting, code editing capabilities, and visualization tools to help users understand and refine the generated code. In some cases, the computing device 104 may also include local processing capabilities to perform preliminary code analysis or to cache frequently used code snippets, potentially reducing the load on the code manager 110 and improving response times for common tasks.

In some implementations, the computing device 104 may be configured to operate in different modes depending on the user's role or the specific requirements of the code generation task. For example, a device may be set up in a “developer mode” with advanced code editing and debugging tools, or in an “administrator mode” with access to system configuration settings and performance metrics. The computing device 104 may be capable of operating in offline modes, allowing users to continue working on code generation tasks even when network connectivity to the code manager 110 and/or remediation manager 112 is temporarily unavailable, with synchronization occurring once the connection is reestablished.

The data source 106 provides data that can be accessed by the components of the computing environment 100 through the network 108. In some implementations, the data source 106 may include repositories of code examples, programming language specifications, or other resources used in code generation and evaluation processes. In some implementations, the data source 106 may be any entity, computing system, model, website, computing device, or data store from which the computing system 102 and/or the computing device 104 may obtain data. As shown, the computing system 102 includes a code manager 110 and a remediation manager 112. In some implementations, the code manager 110 and the remediation manager 112 may be integrated into a single component.

The code manager 110 may be configured to orchestrate various code-related operations and processes. In some implementations, the code manager 110 may include multiple subcomponents designed to handle different aspects of code generation, evaluation, and refinement. These subcomponents may work in concert to provide a comprehensive suite of code management capabilities, potentially improving the efficiency and effectiveness of software development and maintenance tasks within the computing environment 100.

In some implementations, the code manager 110 may interface with both the computing device 104 and the data source 106 through the network 108, facilitating the flow of information between these components. The code manager 110 may receive code generation requests from users via the computing device 104, process these requests using its internal components, and leverage data from the data source 106 to inform its operations. The code manager 110 may interact with the remediation manager 112, potentially sharing relevant code-related information to support incident remediation processes.

The code manager 110 may incorporate machine learning capabilities, potentially allowing it to adapt and improve its code generation and evaluation processes over time. In some implementations, the code manager 110 may maintain a knowledge base of code patterns, best practices, and historical performance data, which it may use to refine its operations. The code manager 110 may include mechanisms for handling different programming languages, frameworks, and coding styles.

The remediation manager 112 may be configured to oversee and coordinate incident remediation processes within the computing environment 100. In some implementations, the remediation manager 112 may include various subcomponents designed to handle different aspects of incident detection, analysis, and resolution. These subcomponents may work together to provide a comprehensive suite of remediation capabilities.

The remediation manager 112 may interface with both the code manager 110 and other components of the computing environment 100 through the network 108. In some cases, the remediation manager 112 may receive incident alerts from monitoring systems, process these alerts using its internal components, and leverage data from the code manager 110 and other sources to inform its remediation strategies. The remediation manager 112 may incorporate machine learning capabilities, potentially allowing it to adapt and improve its incident response processes over time. In some implementations, the remediation manager 112 may maintain a knowledge base of incident patterns, successful remediation strategies, and historical performance data, which it may use to refine its operations.

The remediation manager 112 may include mechanisms for simulating incidents through fault injection, generating and executing remediation scripts, and evaluating the effectiveness of remediation actions. In some implementations, the remediation manager 112 may be capable of handling multi-step remediation processes, addressing complex incidents that require a sequence of corrective actions across different components of the computing environment. The remediation manager 112 may incorporate feedback loops, allowing it to improve its remediation strategies based on the outcomes of previous incident resolution attempts.

FIG. 1B is a block diagram of the code manager 110 of FIG. 1A. The code manager 110 includes an action processing engine 114, a prompt generator 116, a machine learning component 118, a reasoning engine 120, an evaluation engine 122, a semantic validation engine 124, a feedback component 126, and a data store 128. Any of the components 114, 116, 118, 120, 122, 124, 126, or 128 may be implemented using hardware and/or software. In some implementations, any two or more of the action processing engine 114, the prompt generator 116, the machine learning component 118, the reasoning engine 120, the evaluation engine 122, the semantic validation engine 124, the feedback component 126, and the data store 128 may be integrated into the same component (e.g., a single server system or an integrated program).

The action processing engine 114 may be configured to receive and process actions that serve as inputs for code generation tasks. In some implementations, the action processing engine 114 may analyze incoming actions to determine their complexity and structure. This analysis may involve parsing natural language descriptions, identifying key components of the requested action, and categorizing the action based on predefined criteria or learned patterns.

The action processing engine 114 may include functionality to decompose composite actions into atomic sub-actions. This decomposition process may involve breaking down multi-step operations into smaller, more manageable units that can be individually processed and evaluated. In some cases, the action processing engine 114 may utilize natural language processing techniques or rule-based systems to identify logical breakpoints within an action description. The engine may also assess each sub-action to determine if it is automatable, potentially flagging any steps that require human intervention or additional information.

In some implementations, the action processing engine 114 may interface with external systems or databases to gather additional context or information needed to fully understand and process the action. This may include retrieving system-specific details, accessing user preferences, or querying knowledge bases for relevant domain information. The action processing engine 114 may incorporate error handling and validation mechanisms to ensure that processed actions are well-formed and contain all necessary information before being passed to subsequent components in the code generation pipeline.

The prompt generator 116 may be configured to generate prompts for the ML component 118. The prompts may be used for any number of different tasks. The prompt generator 116 may be configured to generate prompts for the ML component 118. The prompts may be used for any number of different tasks. For example, the prompt generator 116 may generate prompts for code generation, syntactic evaluation, reasoning evaluation, feedback gathering, semantic validation, or other tasks. The prompt generator 116 may initiate an instance of the ML component 118 to process the prompt and generate output.

The prompt generator 116 may be configured to create structured inputs for the ML component 118 based on the processed actions received from the action processing engine 114. In some implementations, the prompt generator 116 may utilize templates or schemas to format the action information into a standardized prompt structure that is optimized for the specific large language model being used. The prompt generator 116 may incorporate various contextual elements into the prompts, such as relevant system information, user preferences, or domain-specific knowledge, to provide the ML component 118 with comprehensive inputs for code generation.

In some cases, the prompt generator 116 may implement adaptive prompt generation techniques that evolve based on feedback and performance metrics. The prompt generator 116 may analyze the effectiveness of previously generated prompts by examining the quality and correctness of the resulting code outputs. Using this information, the prompt generator 116 may refine its prompt creation strategies over time, potentially employing machine learning techniques to identify patterns in successful prompts and incorporate those patterns into future prompt generations.

The prompt generator 116 may also include functionality to handle multi-modal inputs and generate corresponding multi-modal prompts. For example, if an action is specified using a combination of natural language, flowcharts, and pseudocode, the prompt generator 116 may be capable of synthesizing these diverse input formats into a cohesive prompt that captures the full intent and complexity of the requested action. This flexibility in input processing and prompt generation may allow the system to accommodate a wide range of user preferences and action specification methods.

The prompt generator 116 may employ a variety of techniques to create effective prompts for the ML component 118. In some implementations, the prompt generator 116 may utilize rule-based prompt generation techniques, which may involve predefined sets of rules and heuristics to construct prompts based on the characteristics of the input action and the desired output. These rules may be designed to capture common patterns and structures in code generation tasks, allowing for consistent and predictable prompt creation.

In some cases, the prompt generator 116 may leverage machine learning techniques to dynamically generate and refine prompts. This approach may involve training models on large datasets of successful code generation examples, enabling the prompt generator to learn optimal prompt structures and content over time. The machine learning-based prompt generation may adapt to different coding styles, programming languages, and task complexities, potentially improving the overall quality and relevance of the generated prompts.

In some cases, the prompt generator 116 may incorporate template-based methods for prompt creation. These templates may serve as pre-defined frameworks or schemas that can be populated with specific details from the input action. The use of templates may help facilitate consistency across different types of code generation tasks while allowing for customization based on the particular requirements of each action. In some implementations, the prompt generator 116 may maintain a library of templates that can be selected and tailored based on factors such as the programming language, task complexity, or specific coding patterns required.

The prompt generator 116 may also combine these different approaches, using a hybrid system that leverages the strengths of rule-based, machine learning, and template-based techniques. This multi-faceted approach may allow the prompt generator to handle a wide range of code generation scenarios, from simple, well-defined tasks to more complex, open-ended programming challenges. By utilizing this diverse set of prompt generation methods, the system may be able to create more nuanced and effective prompts, potentially leading to improved code generation outcomes from the ML component 118.

The ML component 118 may serve as a processing unit for code generation and evaluation tasks within the system. A machine learning (ML) component refers to hardware and/or software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, LLMs, and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, differentiating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point includes a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

In some implementations, the ML component 118 may be based on an LLM architecture, such as a transformer-based model, that has been fine-tuned on extensive datasets of code and programming-related text. This training may enable the ML component 118 to understand and generate code across various programming languages, frameworks, and paradigms. The ML component 118 may be capable of processing natural language inputs, code snippets, and structured prompts to produce relevant code outputs, explanations, and analyses.

In some aspects, the ML component 118 may incorporate multi-task learning capabilities, allowing it to switch between different code-related tasks such as generation, completion, refactoring, and evaluation. The ML component 118 may utilize context-aware processing techniques to maintain coherence and consistency across multiple interactions within a single coding session. In some implementations, the ML component 118 may employ few-shot or zero-shot learning approaches, enabling it to adapt to novel coding tasks or unfamiliar programming languages with minimal additional training. The ML component 118 may integrate retrieval-augmented generation mechanisms, allowing it to access and incorporate relevant information from external knowledge bases or documentation during the code generation process.

The ML component 118 may include built-in safeguards and ethical considerations to facilitate adherence to best practices, security standards, and legal requirements. In some cases, the ML component 118 may utilize a hierarchical decision-making process to balance multiple objectives such as code efficiency, readability, and maintainability. The ML component 118 may feature self-evaluation capabilities, allowing it to assess the quality and potential limitations of its own outputs. This self-awareness may enable the component to provide confidence scores or alternative suggestions when faced with ambiguous or challenging coding tasks. In some implementations, the ML component 118 may be designed with extensibility in mind, allowing for easy integration of new models, techniques, or domain-specific knowledge as the field of AI-assisted coding continues to evolve.

In some implementations, any of the other components of the code manager 110 may include or utilize the ML component 118. For example, the action processing engine 114, prompt generator 116, reasoning engine 120, syntactic evaluation engine 122, semantic validation engine 124, and feedback component 126 may each incorporate aspects of the ML component 118 to enhance their respective functionalities. This integration may allow these components to leverage the advanced natural language processing and code understanding capabilities of the ML component 118. By utilizing the ML component 118, these other components may adapt and improve their performance over time, potentially leading to more accurate code generation, more effective prompt refinement, and more insightful code evaluation. The flexibility of the ML component 118 may enable it to be tailored to the specific needs of each component, potentially improving the overall efficiency and effectiveness of the code manager 110.

The reasoning engine 120 may be configured to extract reasoning explanations associated with the functional correctness of generated code. In some implementations, the reasoning engine 120 may determine sets of similarity and difference evidence items based on analyses of the action and the code functionality. The reasoning engine 120 may be designed to analyze and interpret the generated code in relation to the original action or task specification. In some implementations, the reasoning engine 120 may employ natural language processing techniques to parse both the action description and the generated code, extracting key concepts, intentions, and logical structures. This analysis may allow the reasoning engine 120 to construct a semantic representation of both the desired outcome and the actual code implementation, facilitating a more nuanced comparison beyond simple syntax matching.

The reasoning engine 120 may utilize various analytical approaches to assess the functional correctness of the generated code. In some cases, the engine may employ symbolic reasoning techniques to logically deduce the effects and outcomes of the code execution without actually running the code. In some implementations, the reasoning engine 120 may incorporate machine learning models trained on large datasets of code-to-functionality mappings, enabling it to predict the likely behavior and output of the generated code. These predictions may then be compared against the expected functionality derived from the original action description, allowing the system to identify potential discrepancies or misalignments between the intended and actual code behavior.

In some implementations, the reasoning engine 120 may generate detailed explanations of its analysis process and findings. These explanations may include step-by-step breakdowns of the code's logical flow, identification of key decision points or potential edge cases, and assessments of how well the code addresses different aspects of the original task. The reasoning engine 120 may also highlight areas where the generated code may deviate from best practices or introduce potential vulnerabilities, providing a comprehensive evaluation that goes beyond simple correctness checks. This contextual feedback may be used by other components of the system, such as the feedback component 126, to guide further refinements and improvements in the code generation process.

The syntactic evaluation engine 122 may be designed to perform comprehensive syntax analysis and correction on generated code. In some implementations, the syntactic evaluation engine 122 may utilize a combination of static analysis techniques and language-specific parsing tools to identify potential syntax errors, style violations, and structural issues within the code. The engine may be configured to handle multiple programming languages and may adapt its evaluation criteria based on the specific language and coding standards associated with each task.

The syntactic evaluation engine 122 may work in conjunction with the reasoning engine 120 to provide context-aware syntax checking. By leveraging the reasoning explanations generated by the reasoning engine 120, the syntactic evaluation engine 122 may be able to distinguish between intentional code structures and genuine syntax errors. This approach may allow the engine to make more informed decisions when suggesting corrections, preserving unique or domain-specific code patterns that might otherwise be flagged as errors by traditional syntax checkers. In some cases, the syntactic evaluation engine 122 may consider the original action description and intended functionality when evaluating syntax, ensuring that proposed corrections align with the overall goals of the code generation task.

In some implementations, the syntactic evaluation engine 122 may include an automated correction mechanism that can apply fixes to identified syntax issues. This mechanism may range from simple error corrections, such as adding missing semicolons or correcting indentation, to more complex refactoring operations that improve code structure and readability. The engine may generate multiple correction options for each identified issue, allowing other components of the system or human reviewers to select the most appropriate fix based on context and preferences. Additionally, the syntactic evaluation engine 122 may maintain a learning component that tracks common syntax errors and successful corrections over time, potentially improving its ability to suggest effective fixes for future code generation tasks.

The semantic validation engine 124 may be designed to perform a comprehensive analysis of the generated code's functionality and correctness without relying on code execution or comparison to pre-existing reference solutions. In some implementations, the semantic validation engine 124 may leverage natural language processing techniques and machine learning models to interpret both the original action description and the generated code. This approach may allow the engine to construct semantic representations of the intended functionality and the actual code implementation, facilitating a more nuanced comparison that goes beyond surface-level syntax matching.

In some cases, the semantic validation engine 124 may employ a multi-step validation process that includes generating intermediate representations of the code's functionality. For example, the semantic validation engine 124 may first produce a high-level description of the code's operations, then break this down into more granular functional units. These units may be compared against corresponding elements derived from the original action description. The semantic validation engine 124 may identify specific areas where the generated code may deviate from the intended functionality. The semantic validation engine 124 may incorporate domain-specific knowledge and coding best practices into its analysis, enabling it to evaluate not just the correctness of the code but also its efficiency, maintainability, and adherence to relevant standards or guidelines.

The semantic validation engine 124 may work in conjunction with other components of the system, such as the reasoning engine 120 and the syntactic evaluation engine 122, to provide a holistic assessment of the generated code. In some implementations, the semantic validation engine 124 may generate confidence scores or probability distributions for different aspects of the code's correctness, facilitating a more nuanced evaluation that captures degrees of alignment with the intended functionality. This probabilistic approach may be useful in scenarios where multiple valid implementations are possible, or where the original action description leaves room for interpretation. The results produced by the semantic validation engine 124 may be used to guide further refinements to the code generation process, potentially improving the overall quality and reliability of the system's outputs over time.

The feedback component 126 processes evaluation results and may be configured to obtain feedback based on reasoning explanations. In some implementations, the feedback component 126 may generate a RAG prompt for the ML component 118 and obtain feedback based on the RAG prompt. The feedback component 126 may identify errors associated with generated code and potential solutions to generate the RAG prompt.

The feedback component 126 may be designed to process and synthesize evaluation results from various components of the system, such as the reasoning engine 120, syntactic evaluation engine 122, and semantic validation engine 124. In some implementations, the feedback component 126 may analyze these evaluation results to identify patterns, common issues, and areas for improvement in the generated code. This analysis may involve aggregating feedback from multiple evaluation cycles, prioritizing issues based on their potential impact on code functionality and quality, and generating actionable insights that can be used to refine the code generation process.

In some cases, the feedback component 126 may employ machine learning techniques to enhance its feedback generation capabilities. For example, the feedback component 126 may utilize natural language processing models to translate technical evaluation results into more human-readable feedback that can be easily understood by developers or incorporated into subsequent code generation iterations. The feedback component 126 may maintain a knowledge base of common coding issues and their solutions, which may be updated and refined over time based on the system's performance across various code generation tasks.

The feedback component 126 may interface with the prompt generator 116 to create refined prompts that incorporate learnings from previous code generation attempts. In some implementations, this may involve generating RAG prompts that combine the original action description with relevant context, examples, and guidance derived from the feedback analysis. By iteratively refining prompts based on accumulated feedback, the system may be able to improve its code generation performance over time, potentially leading to more accurate, efficient, and maintainable code outputs.

The data store 128 maintains relevant data for the system operations. In some implementations, the data store 128 may store code catalogs, embedding representations, and other data used in code retrieval and generation processes. The data store 128 may serve as a centralized repository for storing and managing various types of data used by the code manager 110 and its components. In some implementations, the data store 128 may utilize a combination of relational databases, NoSQL databases, and file systems to efficiently organize and retrieve different data structures. The data store 128 may contain code catalogs that include pre-existing code snippets, functions, and modules categorized by programming language, functionality, and domain. These code catalogs may be used by the code retrieval process to quickly identify and retrieve relevant code examples that match incoming action requests.

In some cases, the data store 128 may store embedding representations of code snippets and natural language descriptions. These embeddings may be high-dimensional vector representations generated by machine learning models, capturing semantic and syntactic features of the code and associated descriptions. The embedding representations may facilitate efficient similarity searches and facilitate the retrieval of contextually relevant code examples. In some implementations, the data store 128 may maintain historical data on code generation attempts, including prompts, generated code, evaluation results, and feedback. This historical data may be used to train and fine-tune the various machine learning components of the system, potentially improving the accuracy and effectiveness of code generation and evaluation over time.

The data store 128 may include configuration data for the various components of the code manager 110, such as language-specific syntax rules, coding style guidelines, and customizable evaluation criteria. In some implementations, the data store 128 may employ caching mechanisms to improve access speeds for frequently used data, and may implement data versioning to track changes in code catalogs, embeddings, and other stored information over time. The data store 128 may be designed with scalability in mind, allowing for the efficient handling of growing datasets as the system processes more code generation tasks and accumulates additional knowledge.

In operation, the action processing engine 114 may receive an action from one of the computing device 104. The action may be decomposed into atomic sub-actions, which are then processed to generate prompts using the prompt generator 116. The ML component 118 may generate code based on these prompts. The generated code may then undergo evaluation by the syntactic evaluation engine 122 and semantic validation engine 124. The reasoning engine 120 may extract explanations associated with the code's functional correctness. Based on these evaluations and explanations, the feedback component 126 may generate feedback, which is used to refine prompts for subsequent code generation. In some implementations, the code manager 110 may perform code retrieval processes using embedding representations and retrieval algorithms before initiating code generation. This may allow the system to efficiently reuse existing code when appropriate.

FIG. 1C is a diagram of an example of a process for automated code evaluation and enhancement using large language models. In some implementations, one or more aspects of the process may be performed by the code manager 110 of FIG. 1B.

The process begins with an action 132, which represents an indication of an action to be performed by generated code. In some implementations, the action 132 may include a system administration operation or a shell script task. The action 132 is provided as input to a decision step 134, which determines whether a catalog exists for the given action.

If a catalog exists, the process follows the “Yes” path to the code retrieval process 136. The code retrieval process 136 is configured to efficiently reuse existing code when appropriate. In some implementations, the code retrieval process 136 may include accessing an automation code catalog 136A, which stores pre-existing code snippets and modules. The automation code catalog 136A may interface with the ML component 118, which may be configured to generate embedding representations 136B and 136C. These embedding representations 136B and 136C may capture semantic and syntactic features of the code snippets and associated descriptions. In some implementations, the ML component 118 may utilize natural language processing techniques to create these representations.

The embedding representations 136B and 136C may be processed by a retrieval algorithm 136D. The retrieval algorithm 136D may be configured to perform similarity searches and identify contextually relevant code examples based on the input action. In some implementations, the retrieval algorithm 136D may employ various machine learning techniques, such as cosine similarity or nearest neighbor search, to find the most appropriate code matches.

The output of the retrieval algorithm 136D feeds into a decision step 136E, which determines if there is high confidence in the retrieved code. This confidence assessment may be based on various factors, such as the similarity score between the retrieved code and the input action, or the historical performance of the retrieved code in similar contexts.

If the decision step 136E determines there is high confidence in the retrieved code (following the “Yes” path), the process proceeds directly to generate a final script 140. In some implementations, the final script 140 may represent the output of the overall process, providing code that is expected to perform the indicated action with high reliability. If the decision step 136E determines that no catalog exists for the given action, or if the decision step 136E determines there is not high confidence in the retrieved code, the process follows the “No” path to the code generation process 138. The code generation process 138 is designed to create new code when existing code is not suitable or available.

The code generation process 138 begins with a prompt generator 116, which may be configured to create structured inputs for the ML component 118 based on the action 132. In some implementations, the prompt generator 116 may utilize templates or schemas to format the action information into a standardized prompt structure optimized for the specific large language model being used.

The ML component 118 receives the prompt from the prompt generator 116 and generates code 138A based on this input. In some implementations, the ML component 118 may be an LLM specifically trained for code generation tasks. The generated code 138A represents the initial output of the code generation process. Following the generation of code 138A, an evaluation operation 138B is performed. The evaluation operation 138B may be configured to determine, using the machine learning component, a functionality of the generated code. In some implementations, this may involve performing a semantic validation operation without executing the generated code or comparing the generated code to a ground truth reference.

The evaluation operation 138B may include extracting a reasoning explanation associated with the functional correctness of the generated code. This explanation may provide insights into why the generated code is considered functionally correct or incorrect, facilitating further improvements and refinements. Based on the results of the evaluation operation 138B, an enhancement operation 138C is performed. The enhancement operation 138C may be configured to obtain feedback based on the reasoning explanation and generate a refined prompt by refining the original prompt. This refined prompt may be used to improve subsequent code generation by the LLM.

In some implementations, the enhancement operation 138C may involve identifying syntactic or semantic corrections based on the reasoning explanation. It may also include generating a RAG prompt for the machine learning component to obtain more targeted feedback. The output of the enhancement operation 138C, like the high-confidence path from the code retrieval process, leads to the final script 140. This final script 140 represents the culmination of either the code retrieval or code generation process, providing code that is expected to perform the indicated action effectively. In some implementations, the process illustrated in FIG. 1C may be iterative, with the final script 140 potentially feeding back into the system for further refinement or serving as a new entry in the automation code catalog 136A for future use. This iterative approach may facilitate continual improvement of the code generation and retrieval processes over time.

The process shown in FIG. 1C efficiently combines code retrieval and generation capabilities, ensuring that the system can leverage existing code when possible while also having the flexibility to generate new code when needed. The integration of evaluation and enhancement operations allows for seamless refinement of generated code, thereby enhancing the overall quality and reliability of the automated code evaluation and enhancement system.

FIG. 1D is a diagram of an example of a process for action processing and prompt generation. In some implementations, one or more aspects of the process may be performed by the action processing engine 114 and prompt generator 116 of FIG. 1B.

The process begins with an action 132, which represents an indication of an action to be performed by generated code. In some implementations, the action 132 may include a system administration operation or a shell script task. The action 132 is provided as input to an action segmentation operation 114A.

The action segmentation operation 114A may be configured to decompose the action 132 into one or more atomic sub-actions. In some implementations, the action segmentation operation 114A may utilize natural language processing techniques to analyze the action 132 and identify distinct steps or components that can be processed independently. The output of the action segmentation operation 114A includes any number of atomic sub-actions such as atomic sub-actions 132A and 132B. Atomic sub-actions 132A and 132B represent the individua tasks derived from the original action 132. In some implementations, these atomic sub-actions may correspond to specific system commands, data manipulation operations, or discrete computational steps. The granularity of the atomic sub-actions may facilitate more precise evaluation and processing in subsequent stages of the workflow.

The atomic sub-actions 132A and 132B are provided as input to a decision step 114B. The decision step 114B may be configured to determine whether each atomic sub-action is automatable. In some implementations, this determination may involve analyzing the nature of the sub-action, checking for the availability of necessary resources or permissions, and assessing the feasibility of automated execution. For example, this step may involve determining whether the atomic sub-action is an action that can be performed by generated code.

If the decision step 114B determines that an atomic sub-action is not automatable, the process follows the “No” path to step 114C. Step 114C may be configured to drop the non-automatable atomic sub-action from further processing. This step facilitates proceeding with only actionable and automatable tasks through the workflow, potentially improving the efficiency and reliability of the code generation process.

For atomic sub-actions determined to be automatable, the process follows the “Yes” path from decision step 114B to an action completion operation 114D. The action completion operation 114D may be configured to enhance or refine the automatable atomic sub-actions with additional context or specifications. In some implementations, if the action is not complete, the action completion operation 114D incorporates associated information 114E into the processing of the automatable atomic sub-actions. In some implementations, the associated information 114E may include system-specific details, user preferences, environmental variables, or other contextual data that may be relevant to the execution of the atomic sub-actions. This incorporation of associated information 114E may facilitate the generation of more accurate and context-aware prompts for code generation.

The output of the action completion operation 114D is provided to a prompt generator 116. The prompt generator 116 may be configured to create structured inputs for the machine learning component 118 based on the processed atomic sub-actions and associated information. In some implementations, the prompt generator 116 may utilize templates or schemas to format the action information into a standardized prompt structure optimized for the specific large language model being used.

The prompt generator 116 may employ various techniques to create effective prompts for code generation. In some implementations, the prompt generator 116 may utilize rule-based prompt generation techniques, which may involve predefined sets of rules and heuristics to construct prompts based on the characteristics of the input action and the desired output. These rules may be designed to capture common patterns and structures in code generation tasks, allowing for consistent and predictable prompt creation.

In some implementations, the prompt generator 116 may leverage machine learning techniques to dynamically generate and refine prompts. This approach may involve training models on large datasets of successful code generation examples, enabling the prompt generator to learn optimal prompt structures and content over time. The machine learning-based prompt generation may adapt to different coding styles, programming languages, and task complexities, potentially improving the overall quality and relevance of the generated prompts.

The process illustrated in FIG. 1D decomposes complex actions into manageable atomic sub-actions, evaluates their automatability, and incorporates relevant contextual information to generate refined prompts for code generation. This approach may facilitate more precise and context-aware code generation, potentially improving the overall quality and applicability of the generated code in various system administration and shell scripting scenarios.

FIG. 1E is a diagram of an example 142 of a process for automated code evaluation and enhancement using large language models. In some implementations, one or more aspects of the process may be performed by the code manager 110 of FIG. 1B.

The process begins with an action 132, which represents an indication of an action to be performed by generated code. In some implementations, the action 132 may include a system administration operation or a shell script task. The action 132 is provided as input to a prompt creation operation 116A, which may be configured to generate a prompt for code generation based on the received action. The prompt creation operation 116A interfaces with an ML component 118, which may be an LLM configured to generate code based on the provided prompt. In some implementations, the ML component 118 may include multiple machine learning models or algorithms working in conjunction to process the input and generate appropriate code outputs.

The ML component 118 produces generated code 138A based on the prompt received from the prompt creation operation 116A. The generated code 138A represents the initial output of the code generation process and may include various programming constructs and logic to perform the indicated action. Following the generation of code 138A, a bash script syntax checking operation 122A is performed. This operation may be configured to analyze the generated code for syntactic correctness, specifically focusing on bash script syntax. In some implementations, the bash script syntax checking operation 122A may utilize specialized parsers or static analysis tools to identify potential syntax errors or style violations.

The results of the bash script syntax checking operation 122A are then processed by another prompt creation operation 116B. This operation may be configured to generate a new prompt based on the syntax checking results, potentially requesting corrections or clarifications for any identified syntax issues.

The prompt creation operation 116B may generate a structured input that encapsulates the syntax checking results and any identified issues. This prompt may include details about specific syntax errors, their locations within the code, and potential corrections or alternatives. In some implementations, the prompt may incorporate contextual information about the original action and the intended functionality of the code to guide the correction process.

The ML component 118 receives this syntax-focused prompt and processes it to generate syntactically correct code 138D. In this iteration, the ML component 118 may leverage its understanding of bash script syntax and common coding patterns to address the identified issues. The ML component 118 may analyze the provided syntax error information, consider the suggested corrections, and apply its knowledge to modify the code accordingly. In some cases, the ML component 118 may generate multiple alternative corrections for a given syntax issue. The ML component 118 may evaluate these alternatives based on factors such as code readability, efficiency, and adherence to best practices. The ML component 118 may consider the broader context of the code and ensure that syntax corrections do not inadvertently alter the intended functionality.

The syntactically correct code 138D produced by the ML component 118 may incorporate the necessary fixes while preserving the original logic and purpose of the code. In some implementations, the ML component 118 may provide explanations or comments alongside the corrected code, detailing the changes made and the reasoning behind them. This approach may enhance transparency and facilitate learning for both the system and potential human reviewers.

A prompt creation operation 116C may be initiated to generate a prompt for code explanation. This prompt may be designed to elicit a comprehensive description of the code's functionality, including its purpose, key components, and expected behavior. The ML component 118 processes this prompt to generate a code explanation 144, which may provide valuable context for subsequent semantic validation steps.

The code explanation 144 generated by the ML component 118 may provide a detailed breakdown of the syntactically correct code 138D. This explanation may include a high-level overview of the code's purpose, as well as more granular descriptions of individual functions, loops, and conditional statements. In some implementations, the code explanation 144 may use natural language to describe the logic flow, data structures, and algorithms employed in the code. The explanation 144 may highlight key variables, their purposes, and how they interact within the code. In some cases, the code explanation 144 may include examples of expected inputs and outputs, helping to illustrate the code's behavior under different scenarios. The ML component 118 may generate explanations that are tailored to different levels of technical expertise, potentially providing both simplified overviews and more in-depth technical descriptions.

In some implementations, the code explanation 144 may include annotations or comments inline with the code snippets, providing context-specific explanations for particular code blocks or lines. This approach may help in understanding the rationale behind specific coding decisions and how they contribute to the overall functionality. The code explanation 144 may address potential edge cases or limitations of the generated code, providing insights into how the code might behave under unusual or extreme conditions. In some cases, the explanation may suggest possible optimizations or alternative approaches that could be considered for improving the code's performance or robustness.

By providing a comprehensive code explanation 144, the system may facilitate better understanding and validation of the generated code, potentially bridging the gap between the technical implementation and the original action requirements. This explanatory step may be particularly valuable in scenarios where the generated code is to be reviewed, modified, or integrated into existing systems by human developers or system administrators.

Another prompt creation operation 116D is configured to generate a prompt for code checking. This prompt is provided to the ML component 118, which performs a semantic validation operation to determine the functional correctness of the generated code without executing the code or comparing it to a ground truth reference. The semantic validation engine 124 receives inputs from both the code explanation 144 and the ML component 118's code checking output. In some implementations, the semantic validation engine 124 may be configured to compare the intended functionality (derived from the code explanation) with the actual functionality (determined through semantic analysis) to assess the correctness of the generated code. In some implementations, the semantic validation engine 124 may employ various techniques to perform its analysis, such as symbolic reasoning or machine learning-based prediction of code behavior. The semantic validation engine 124 may generate detailed explanations of its findings, potentially including step-by-step breakdowns of the code's logical flow and assessments of how well the code addresses different aspects of the original task.

The process culminates in an output 146 that combines the syntactically correct script 138D, code explanation 144, and semantic validation 124A results. This comprehensive output may provide a holistic view of the generated code, including its syntactic correctness, functional description, and semantic validity.

The output 146 may be utilized in various ways to enhance the code generation and evaluation process. In some implementations, the combined information from the syntactically correct script 138D, code explanation 144, and semantic validation 124A results may serve as a comprehensive report for developers or system administrators. This report may provide valuable insights into the generated code's structure, functionality, and correctness without requiring manual code execution or comparison to reference solutions. In some cases, the output 146 may be used as input for further refinement of the code generation process. The semantic validation results may highlight areas where the generated code does not fully meet the intended functionality, potentially triggering additional iterations of code generation or prompting human intervention for complex cases.

The process illustrated in FIG. 1E demonstrates a multi-faceted approach to code generation and evaluation, incorporating syntax checking, semantic validation, and natural language explanation generation. This approach may facilitate more robust and reliable code generation, potentially improving the overall quality and correctness of automatically generated code for various system administration and shell scripting tasks.

In some implementations, the process may include additional feedback loops or refinement stages. For example, the semantic validation results could be used to further refine the code generation prompts, potentially leading to iterative improvements in the generated code's functionality and correctness. By combining syntactic and semantic evaluation with natural language explanations, the process may facilitate better understanding and validation of generated code, potentially bridging the gap between automated code generation and human comprehension. This approach may be particularly valuable in scenarios where generated code needs to be reviewed or integrated into existing systems by human developers or system administrators.

FIG. 1F is a diagram of an example of a process for performing semantic validation of generated code. In some implementations, one or more aspects of the process may be performed by the semantic validation engine 124 of FIG. 1B.

The semantic validation engine 124 receives a prompt 124B and code functionality 124C as inputs. In some implementations, the prompt 124B may include a natural language representation of an action to be performed by generated code. The prompt 124B may be generated by the prompt generator 116 based on an indication of an action received from a user or system. The code functionality 124C may include a description or representation of the functionality of code generated by an LLM in response to the prompt 124B.

The semantic validation engine 124 includes a similarity analysis module 124D and a difference analysis module 124E. In some implementations, the similarity analysis module 124D may be configured to determine a set of similarity evidence items based on performing a similarity analysis associated with the prompt 124B and the code functionality 124C. The similarity analysis module 124D may employ natural language processing techniques to identify common concepts, structures, or intentions between the prompt and the generated code functionality.

The difference analysis module 124E may be configured to determine a set of difference evidence items based on performing a difference analysis associated with the prompt 124B and the code functionality 124C. In some implementations, the difference analysis module 124E may identify discrepancies, missing elements, or potential misalignments between the intended action specified in the prompt and the actual functionality of the generated code.

The outputs of the similarity analysis module 124D and the difference analysis module 124E are provided to evidence extraction modules 124F and 124G, respectively. In some implementations, the evidence extraction modules may be configured to process the results of the similarity and difference analyses to extract specific, actionable evidence items. These evidence items may represent points of alignment or divergence between the prompt and the code functionality.

The evidence extraction module 124F processes the output of the similarity analysis module 124D to extract similarity evidence items. These items may include specific code structures, functional elements, or semantic concepts that align closely with the intended action specified in the prompt. In some implementations, the similarity evidence items may be represented as structured data, allowing for easier comparison and ranking in subsequent stages of the process.

Similarly, the evidence extraction module 124G processes the output of the difference analysis module 124E to extract difference evidence items. These items may highlight areas where the generated code functionality deviates from or fails to fully address the requirements specified in the prompt. In some implementations, the difference evidence items may include suggestions for potential improvements or modifications to better align the code with the intended action.

The extracted evidence items from both the similarity and difference analyses are then provided to an evidence ranking module 124H. In some implementations, the evidence ranking module 124H may be configured to evaluate and prioritize the evidence items based on their relevance, importance, and potential impact on the overall functional correctness of the generated code.

The evidence ranking module 124H may employ various techniques to rank the evidence items. In some implementations, ranking the evidence items may involve performing additional similarity or difference analyses to assess the consistency of each item across multiple evaluations. The evidence ranking module 124H may assign, to each item of the set of similarity evidence items or the set of difference evidence items, a respective consistency score of a plurality of consistency scores. The respective consistency score may correspond to a number of times that a respective item appears across multiple analyses.

In some implementations, the evidence ranking module 124H may utilize a validation-based approach for ranking. This may involve determining an expected output of the generated code based on the evidence items, generating a sample output using the generated code and a sample input corresponding to an evidence item, and determining a validation score based on a comparison between the expected output and the sample output. The evidence items may then be ranked based on these validation scores.

The ranked evidence items are provided as input to a semantic validation module 124I. In some implementations, the semantic validation module 124I may be configured to determine the functional correctness of the generated code based on the ranked evidence items. The semantic validation module 124I may analyze the relative importance and implications of the similarity and difference evidence to make a holistic assessment of how well the generated code aligns with the intended action specified in the prompt.

The semantic validation module 124I generates a semantic validation output, which may include a determination of the functional correctness of the generated code. In some implementations, this output may also include a reasoning explanation associated with the functional correctness of the generated code. The reasoning explanation may include at least one of the set of similarity evidence items or the set of difference evidence items, providing insight into why the code is considered functionally correct or incorrect.

In this configuration, the semantic validation engine 124 facilitates the evaluation of generated code without requiring code execution or comparison to a ground truth reference. The integration of similarity and difference analyses, evidence extraction, and ranking allows for a nuanced assessment of code functionality, potentially improving the accuracy and reliability of automated code generation systems. The semantic validation output may be used to generate feedback and refine prompts, leading to iterative improvements in the code generation process.

FIG. 1F is a diagram of an example of a process for processing and generating feedback for code refinement. In some implementations, one or more aspects of the process may be performed by the feedback component 126 of FIG. 1A.

The process begins with model feedback 126A, which serves as the initial input for the feedback processing pipeline. In some implementations, the model feedback 126A may include evaluations, comments, or suggestions related to generated code. This feedback may originate from automated model-based assessments. The model feedback 126A may be structured in various formats, such as natural language comments, numerical ratings, or predefined categories of feedback.

The model feedback 126A flows to a sentiment extraction module 126B. This module may be configured to analyze the emotional tone or overall attitude expressed in the feedback. In some implementations, the sentiment extraction module 126B may employ natural language processing techniques to categorize the feedback as positive, negative, or neutral. The sentiment information extracted at this stage may be used to prioritize or weight different aspects of the feedback in subsequent processing steps. The sentiment extraction module 126B may facilitate prioritizing feedback. In some implementations, feedback with strongly negative sentiment may be given higher priority, as it may indicate more critical issues that need immediate attention. Conversely, positive sentiment feedback may be used to reinforce successful code generation patterns or highlight areas of the code that are particularly well-implemented.

Following the sentiment extraction, the process continues to a key symptom/evidence extraction module 126C. This module may be configured to identify and extract specific issues, errors, or areas of improvement mentioned in the feedback. In some implementations, the key symptom/evidence extraction module 126C may utilize machine learning algorithms to recognize patterns or common problems in the feedback. The extracted information may include code snippets, error messages, performance metrics, or descriptions of unexpected behavior. The key symptom/evidence extraction module 126C may be designed to handle a wide range of feedback types. In some implementations, this module may be capable of processing both structured feedback (e.g., standardized error reports or performance metrics). The module may employ advanced natural language understanding techniques to extract relevant information from complex or technical descriptions.

The information extracted by the key symptom/evidence extraction module 126C then flows to a retrieval based context generation stage 126D. This module may be configured to gather relevant contextual information based on the extracted symptoms or evidence. In some implementations, the retrieval based context generation module 126D may query databases, documentation, or previous code examples to provide additional context for the identified issues. This context may include relevant coding standards, best practices, or similar problems and their solutions from past experiences. The retrieval based context generation module 126D may leverage large-scale knowledge bases to provide comprehensive context for identified issues. In some implementations, this module may access not only internal code repositories and documentation but also external resources such as open-source libraries, coding forums, or academic publications. The context generated by this module may help in understanding the root causes of identified problems and in suggesting potential solutions based on established best practices or similar cases.

The feedback component 126 also includes a fine-tuned model for feedback prompt generation 126E. This model may be configured to process inputs from both the model feedback 126A and the retrieval based context generation 126D. In some implementations, the fine-tuned model for feedback prompt generation 126E may be an LLM specifically trained on code-related feedback and refinement tasks. The model may analyze the original feedback, extracted sentiments and symptoms, and the generated context to produce refined feedback prompts.

The fine-tuned model for feedback prompt generation 126E may generate prompts that are tailored to improve subsequent code generation by the LLM. In some implementations, these prompts may include specific instructions for code modifications, suggestions for alternative approaches, or requests for clarification on certain aspects of the code. The prompts generated by the fine-tuned model for feedback prompt generation 126E may be structured in a way that facilitates clear communication between the feedback system and the code generation LLM.

The fine-tuned model for feedback prompt generation 126E may be continually updated based on the effectiveness of its generated prompts. In some implementations, the model may track how well its prompts lead to improved code in subsequent iterations, and use this information to refine its prompt generation strategies. This adaptive approach may allow the feedback system to become more effective over time, learning from its successes and failures to produce increasingly relevant and actionable feedback.

The process illustrated in FIG. 1G may facilitate iterative refinement of generated code. In some implementations, the refined prompts produced by the fine tuned model for feedback prompt generation 126E may be fed back into the code generation process, potentially leading to improved code outputs in subsequent iterations. This feedback loop may allow for continuous improvement of the code generation system over time.

FIG. 1H is a block diagram of an example of the remediation manager 112. As shown, the remediation manager 112 includes a MELT fingerprint engine 148, a fault engine 150, an incident event aggregator (IEA) 152, an ML component 154, and a data store 156. These components are configured to interact with each other to facilitate automated incident detection, analysis, and remediation in complex computing environments. In some implementations, two or more of these components may be combined into a single component. In some implementations, one or more of these components may be split into multiple components.

The MELT fingerprint engine 148 may be configured to obtain baseline data indicative of at least one of a metric, an event, a log, or a trace associated with a computing environment in a fault-free state. In some implementations, the MELT fingerprint engine 148 may collect and process metrics, events, logs, and traces data to generate fingerprints of system states. These fingerprints may serve as reference points for normal system operation, facilitating the detection of anomalies or incidents.

The MELT fingerprint engine 148 may be configured to capture and analyze comprehensive system state information across multiple dimensions. In some implementations, the MELT fingerprint engine 148 may continually monitor and collect data related to metrics, events, logs, and traces (MELT) from various components of the computing environment. This holistic approach to data collection may facilitate the creation of detailed fingerprints that represent the system's behavior and performance characteristics under normal operating conditions.

The MELT fingerprint engine 148 may employ data processing and analysis techniques to transform raw MELT data into meaningful fingerprints. In some cases, the MELT fingerprint engine 148 may utilize machine learning algorithms to identify patterns, correlations, and dependencies within the collected data. These algorithms may help in distinguishing between normal variations in system behavior and potential anomalies that could indicate emerging issues. For example, the MELT fingerprint engine 148 may include or utilize the ML component 154. The MELT fingerprint engine 148 may incorporate time-series analysis to capture temporal aspects of system behavior, which may facilitate the detection of gradual changes or cyclical patterns that might be indicative of underlying problems.

In some implementations, the MELT fingerprint engine 148 may be capable of adapting to changes in the computing environment over time. The MELT fingerprint engine 148 may periodically update its baseline fingerprints to account for legitimate changes in system configuration, workload patterns, or infrastructure upgrades. This adaptive capability may help maintain the accuracy and relevance of the fingerprints, potentially reducing false positives in anomaly detection. Additionally, the MELT fingerprint engine 148 may support the creation of multiple fingerprints for different operational modes or system states, allowing for more nuanced and context-aware incident detection and remediation processes.

The fault engine 150 may be configured to inject a fault into the computing environment to simulate an incident. In some implementations, the fault engine 150 may operate to detect and analyze faults within the system. The fault engine 150 may include mechanisms for simulating various types of incidents, such as CPU throttling, network latency introduction, or application errors. This controlled fault injection may facilitate proactive testing and improvement of incident response capabilities.

The fault engine 150 may be configured to simulate any number of different incident scenarios within the computing environment 100. In some implementations, the fault engine 150 may include a library of predefined fault types, such as resource exhaustion, network failures, application crashes, or data corruption events. This library may be extensible, allowing system administrators or developers to add custom fault types specific to their environment or application stack. The fault engine 150 may utilize sophisticated algorithms to determine appropriate faults to inject based on various factors, including the current system state, historical incident patterns, or predefined testing schedules, among other examples.

In some cases, the fault engine 150 may incorporate machine learning capabilities to enhance its fault injection strategies. For example, the fault engine 150 may include or utilize the ML component 154. These capabilities may enable the fault engine 150 to learn from past incident data and system responses to generate more realistic and relevant fault scenarios over time. The fault engine 150 may include a configuration interface that allows users to fine-tune fault parameters, such as duration, intensity, or scope of impact. This level of control may facilitate the creation of multi-stage incident scenarios that mimic real-world problems encountered in production environments.

The fault engine 150 may work in close coordination with other components of the remediation manager 112, particularly the MELT fingerprint engine 148 and the IEA 152. In some implementations, the fault engine 150 may use the baseline fingerprints generated by the MELT fingerprint engine 148 to ensure that faults are injected in a manner that produces detectable deviations from normal system behavior. The fault engine 150 may provide detailed metadata about injected faults to the IEA 152, which may facilitate improving the accuracy of incident detection and classification processes. This integration may facilitate more comprehensive testing and validation of the entire incident remediation pipeline, from initial detection through to resolution and system recovery.

The IEA 152 may be configured to obtain a set of fault data associated with a fault injected by the fault engine 150. In some implementations, the IEA 152 may aggregate and process incident events from the system. The IEA 152 may collect various aspects of the system's state during the incident, including metrics that deviate from baseline values, newly generated error logs, and changes in application behavior.

The IEA 152 may be configured to handle any number of different incident data types and sources. In some implementations, the IEA 152 may incorporate advanced data ingestion and normalization capabilities, allowing it to process structured, semi-structured, and unstructured data from various system components, monitoring tools, and application logs. The IEA 152 may utilize machine learning algorithms to automatically categorize and prioritize incoming incident data, potentially improving the efficiency of incident triage and response processes. For example, the IEA 152 may include or utilize the ML component 154. In some implementations, the IEA 152 may include real-time data streaming capabilities, which may facilitate processing and analyzing incident data as it is generated, thereby facilitating rapid detection and response to emerging issues.

In some implementations, the IEA 152 may implement correlation and pattern recognition techniques to identify relationships between seemingly disparate incident events. This capability may help in uncovering the root causes of complex, multi-faceted incidents that span multiple system components or services. The IEA 152 may maintain a historical database of incident data, which may be used for trend analysis, predictive modeling, and continuous improvement of incident response strategies. In some implementations, the IEA 152 may integrate with external threat intelligence feeds or vulnerability databases, enriching the incident data with contextual information that may aid in assessing the potential impact and urgency of detected issues.

The IEA 152 may provide a flexible and extensible interface for other components of the remediation manager 112 to access and utilize the aggregated incident data. In some implementations, the IEA 152 may offer APIs or query languages that help the ML component 154 or other analysis tools to efficiently retrieve and process relevant incident information. The IEA 152 may also include visualization capabilities, generating interactive dashboards or reports that provide insights into incident trends, system health, and the effectiveness of remediation actions. These features may enhance situational awareness and support data-driven decision-making in incident management processes.

The ML component 154 may be configured to generate (e.g., using an LLM) a remediation script based on the fault data. In some implementations, the ML component 154 may process data and generate remediation actions based on the collected information. The ML component 154 may be an LLM trained on historical incident data, system documentation, and best practices for incident resolution. In some implementations, the ML component 154 may be, be similar to, include, or be included in the ML component 118.

The ML component 154 may be configured to leverage any number of different machine learning techniques, including deep learning and natural language processing, to analyze fault data and generate remediation scripts. In some implementations, the ML component 154 may utilize a combination of supervised and unsupervised learning algorithms to identify patterns in incident data, correlate symptoms with root causes, and predict the most appropriate remediation actions. The ML component 154 may be trained on a diverse dataset of historical incidents, successful remediation strategies, and system documentation, which may facilitate a comprehensive understanding of various fault scenarios and their resolutions.

In some cases, the ML component 154 may employ transfer learning techniques to adapt its knowledge to new or evolving system environments. This approach may allow the ML component 154 to generalize its learning from one type of computing environment to another, which may facilitate improving its performance in handling novel incident types or system configurations. The ML component 154 may incorporate reinforcement learning mechanisms, enabling it to refine its remediation strategies based on the outcomes of previous actions. This iterative learning process may help the ML component 154 to continuously improve its decision-making capabilities and adapt to changing system dynamics over time.

The ML component 154 may include a natural language generation module that allows it to produce human-readable explanations for its remediation decisions. In some implementations, this feature may facilitate collaboration between the automated remediation system and human operators, providing insights into the reasoning behind specific remediation actions. The ML component 154 may be capable of handling multi-modal input data, including structured metrics, unstructured log files, and even visual data such as system topology diagrams or performance graphs. This versatility may enable the ML component 154 to develop a more comprehensive understanding of the system state and generate more contextually appropriate remediation scripts.

The data store 156 may be configured to maintain information including fingerprint data, fault data, and remediation results. In some implementations, the data store 156 may store code catalogs, embedding representations, and other data used in code retrieval and generation processes. The data store 156 may serve as a centralized repository for storing and managing various types of data used by the remediation manager 112 and its components.

The data store 156 may be implemented using a variety of storage technologies or architectures to manage and retrieve data for incident remediation processes. In some implementations, the data store 156 may utilize a combination of relational databases for structured data, NoSQL databases for semi-structured and unstructured data, or distributed file systems for large-scale data storage, among other examples. The data store 156 may incorporate indexing and search capabilities to facilitate rapid retrieval of relevant information during incident analysis and remediation. In some cases, the data store 156 may employ machine learning-based indexing techniques that automatically categorize and tag incoming data, which may facilitate improving the efficiency of subsequent search and analysis operations. The data store 156 may implement data versioning and change tracking mechanisms, which may help the system to maintain historical records of fingerprints, fault data, and remediation results. This historical data may be used for trend analysis, auditing, and continuous improvement of the incident remediation processes.

In some implementations, the data store 156 may support real-time data ingestion and processing capabilities, enabling it to handle high-volume, high-velocity data streams generated during incident detection and remediation activities. The data store 156 may incorporate data compression and archiving techniques to manage storage costs while maintaining accessibility to historical data. In some implementations, the data store 156 may implement robust security measures, including encryption at rest and in transit, access controls, and audit logging, to protect sensitive incident and system data. These security features may help ensure the integrity and confidentiality of the stored information, which may be useful for maintaining trust in the automated incident remediation system.

In operation, the MELT fingerprint engine 148 may continually, periodically, or in response to a trigger event collect baseline data from the computing environment. This baseline data may be stored in the data store 156 for future reference. When an incident needs to be simulated, the fault engine 150 may inject a fault into the system, triggering the IEA 152 to collect fault data. The fault data collected by the IEA 152 may be provided to the ML component 154 for analysis. In some implementations, the ML component 154 may generate a remediation script based on the fault data and historical information stored in the data store 156. The generated remediation script may then be provided for execution in the computing environment.

The MELT fingerprint engine 148 may obtain remediation data corresponding to the execution of the remediation script. This remediation data may be compared to the original baseline data to determine the effectiveness of the remediation. In some implementations, the remediation manager 112 may determine a remediation score based on a similarity between the baseline data and the remediation data. This remediation score may be determined based on a weighted combination of metric similarity, log similarity, event resolution status, and trace similarity. The remediation score may be used to modify the inputs or prompts used by the ML component 154 for generating subsequent remediation scripts. In some implementations, this may involve applying in-context learning based on prior successful remediation scores, potentially improving the system's ability to generate effective remediation scripts over time.

In some implementations, the fault engine 150 may be capable of injecting multiple faults, allowing the system to simulate complex incident scenarios. The ML component 154 may generate multiple remediation scripts corresponding to these various faults. These generated remediation scripts may be ranked based on their corresponding remediation scores, allowing the system to prioritize the most effective remediation strategies. The remediation manager 112 may incorporate feedback loops, allowing it to improve its remediation strategies based on the outcomes of previous incident resolution attempts. In some implementations, this may involve training the ML component 154 by applying a reinforcement learning algorithm using Proximal Policy Optimization (PPO), where the remediation score is used as a reward signal to update a policy network that influences remediation script generation.

In some implementations, the fault engine 150 may use machine learning trained to predict fault types based on historical incident data. This predictive capability may allow the system to focus on simulating the most relevant or likely incident scenarios, potentially improving the overall effectiveness of the incident remediation process. The remediation manager 112 may be designed with scalability in mind, allowing it to handle incident remediation across various scales of computing environments. In some implementations, the remediation manager 112 may be capable of interfacing with multiple types of computing environments, including cloud-based infrastructures, on-premises systems, or hybrid environments.

FIG. 1I is a data flow diagram of an example 158 of a process for automated incident remediation. In some implementations, one or more aspects of the process may be performed by the remediation manager 112 of FIGS. 1A and 1H.

The example 158 includes an entity 160, which may be a computing system or computing environment in which incidents may occur. In some implementations, the entity 160 may be similar to the computing environment 100 described in FIG. 1A. As shown, the entity 160 includes an execution engine 162. The execution engine 162 may be configured to perform various operations within the entity 160, including executing code and collecting system data.

As shown, the MELT fingerprint engine 148 may obtain baseline data, which is represented by baseline MELT data 164. The baseline MELT data 164 may be indicative of one or more metrics, events, logs, or traces associated with the computing environment in a fault-free state. This baseline data serves as a reference point for normal system operation. In some implementations, the baseline MELT data 164 may be collected by an APM component 166.

The APM component 166 may be configured to monitor and analyze the performance of applications and services within the entity 160. In some implementations, the APM 166 may be part of the remediation manager 112 or may be a separate system that interfaces with the remediation manager 112.

Using the baseline MELT data 164, a baseline MELT fingerprint 168 is generated. The baseline MELT fingerprint 168 represents a comprehensive snapshot of the system's state under normal, fault-free conditions. For example, the baseline MELT fingerprint 168 may be generated by the MELT fingerprint engine 148 described in FIG. 1H.

The baseline MELT fingerprint 168 may be generated through a comprehensive process that aggregates and analyzes various system metrics, events, logs, and traces collected during normal operation. In some implementations, the MELT fingerprint engine 148 may employ data processing techniques to distill the raw baseline MELT data 164 into a compact, yet informative representation of the system's healthy state. This process may involve statistical analysis, feature extraction, or dimensionality reduction methods, among others, to identify relevant and differentiating characteristics of the system's normal behavior.

The generation of the baseline MELT fingerprint 168 may incorporate machine learning algorithms to detect patterns and correlations across different data types. For example, the MELT fingerprint engine 148 may use clustering algorithms to group similar metrics or events, or employ anomaly detection techniques to establish normal ranges for various system parameters. In some cases, the fingerprint generation process may involve time-series analysis to capture temporal patterns and cyclical behaviors that are characteristic of the system's normal operation. The resulting baseline MELT fingerprint 168 may be represented as a multi-dimensional vector or a set of statistical descriptors that encapsulate the essence of the system's fault-free state.

In some implementations, the baseline MELT fingerprint 168 may be updated and refined over time to account for gradual changes in the system's normal behavior. The MELT fingerprint engine 148 may employ adaptive learning techniques to adjust the fingerprint based on long-term trends or seasonal variations in system performance. The baseline MELT fingerprint 168 may include metadata about the conditions under which it was generated, such as time stamps, system configuration details, or workload characteristics, which may provide context for future comparisons and analyses.

The fault engine 150 may perform a fault injection 170 operation. The fault injection 170 operation may be configured to introduce various types of faults or errors into the system to test its resilience and remediation capabilities. In some implementations, the fault engine 150 may register an expected incident (shown as “expected incident registration” 172) with the IEA 152.

The fault injection and subsequent system response generate metrics 174 and may trigger an incident 176. The metrics 174 may include various performance indicators and system measurements that deviate from the baseline due to the injected fault. The incident 176 represents the system's recognition of an abnormal state or error condition resulting from the fault injection.

The process then involves obtaining a set of fault data associated with the fault. This is represented by the fault MELT data 178. The fault MELT data 178 may include metrics, events, logs, and traces that capture the system's state during the simulated incident. In some implementations, the fault MELT data 178 may be collected by the MELT fingerprint engine 148.

Using the fault MELT data 178, the MELT fingerprint engine 148 generates a fault MELT fingerprint 180. The fault MELT fingerprint 180 provides a comprehensive representation of the system's state during the incident. The process continues with the collection and processing of incident data 182. The incident data 182 may include detailed information about the nature of the incident, its impact on the system, and any automatic responses triggered by the system. In some implementations, the incident data 182 may be collected and processed by the IEA 152.

Based on the incident data 182, a remediation request 184 is generated. The remediation request 184 may include information necessary for the system to generate an appropriate remediation script. In some implementations, the remediation request 184 may be formulated by the IEA 152 or by a separate component of the remediation manager 112.

The remediation request 184 may include a set of data that the code generation component 138 can use to formulate an effective remediation strategy. In some implementations, the remediation request 184 may include detailed information about the incident, such as the type of fault detected, the affected components or services, and the severity level of the incident. The request may incorporate relevant contextual information, such as the current system state, historical incident data, and any environmental factors that may influence the remediation process.

In some implementations, the remediation request 184 may contain specific constraints or requirements for the remediation script. These constraints may include factors such as maximum allowable downtime, resource utilization limits, or prioritization of certain services or components. The request may specify preferred remediation methods or techniques based on past successes or predefined policies. In some implementations, the remediation request 184 may include references to relevant knowledge base articles, best practices, or previously successful remediation strategies that could guide the generation of the remediation script.

The remediation request 184 may be dynamically generated based on real-time analysis of the incident data 182 and the fault MELT fingerprint 180. In some implementations, the request may be iteratively refined as more information becomes available or as the incident evolves. The remediation request 184 may include metadata such as timestamps, request priorities, and correlation identifiers to facilitate tracking and auditing of the remediation process. This comprehensive and adaptable nature of the remediation request 184 may help the ML component 154 to generate more targeted and effective remediation scripts, which may facilitate improving the overall success rate of the automated incident remediation system.

The code generation component 138 generates a remediation script 186 based on the remediation request. The code generation component 138 may analyze fault data, incident information, and historical remediation data to produce a script tailored to address the specific incident. The generated remediation script 186 may be provided for execution in the computing environment. In some implementations, the execution engine 162 may execute the remediation script 186 within the entity 160.

Based on the execution of the remediation script, the process may include obtaining remediation results 188. The remediation results 188 may include information about the success or failure of the remediation attempt, as well as updated system metrics and state information. In some implementations, the remediation results 188 may be collected by the execution engine 162 or the APM 166.

The process may also include a feedback 190 step. The feedback 190 may involve analyzing the remediation results and updating the system's knowledge base or machine learning models to improve future remediation attempts. In some implementations, the feedback 190 may be processed by the ML component 154 or a separate feedback processing component within the remediation manager 112.

In some implementations, the process may include determining a remediation score based on a similarity between the baseline data and the remediation data. This score may be calculated by comparing the baseline MELT fingerprint 168 with a new MELT fingerprint generated from the remediation results 188. The remediation score may be determined based on a weighted combination of metric similarity, log similarity, event resolution status, and trace similarity.

For example, the system may be configured to evaluate and score the effectiveness of automated incident remediation actions generated by an LLM. The scoring process may compare the system's state after executing a candidate remediation action against a previously recorded ground truth state, using a combination of metrics, events, logs, and traces (collectively referred to as “MELT” data). This comparison may support a similarity-based scoring framework that can be leveraged for action refinement, in-context learning, and reinforcement learning.

Following the execution of a candidate remediation script, the system may acquire a new MELT fingerprint that reflects the post-remediation state of the environment. This fingerprint may then be compared to a reference fingerprint-such as a known good or ground truth state-that represents the healthy configuration of the system prior to the fault condition. In some implementations, the system may compute similarity scores for each component of the MELT data: Metric similarity (M) may be determined by comparing post-remediation system metrics (e.g., CPU utilization, memory consumption) to the corresponding ground truth values; event similarity (E) may be represented by a binary or scalar value that reflects whether the originating incident has been resolved; log similarity (L) and Trace similarity (T) may be calculated using natural language processing techniques, such as TF-IDF, cosine similarity, or other text analysis methods applied to error messages, warnings, or stack traces.

A representative MELT score (S_MELT) may be calculated using a weighted or unweighted aggregation of the individual components. For instance, in one embodiment:

$${S}_{MELT} = \frac{M + E + L + T}{4}$$

However, alternative formulations may be used in other embodiments. For example, certain systems may assign greater weight to the “Event” component to prioritize incident resolution, or may exclude trace data if such information is unavailable in a given environment.

To further evaluate the remediation action, the system may compute an Action Execution Score (AES), which reflects the performance and correctness of the action. The AES may include factors such as success rate, indicating whether the action fully resolved, partially resolved, or failed to resolve the issue; error rate, capturing runtime issues encountered during script execution; or performance impact, which may assess the action's side effects, such as increased latency or resource usage.

In one example, the AES may be computed as:

$$AES = \frac{Success Rate + Error Rate + Performance Impact}{3}$$

However, in other implementations, these sub-scores may be weighted differently or computed using alternate heuristics, depending on operational priorities or deployment constraints. A Total Action Score (TAS) may be computed as a function of the MELT score and the AES. For example:

TAS=(S_{MELT}×α)+(AES×β)

where α and β are weighting factors that may be selected based on empirical results, use-case specificity, or system tuning goals. In one embodiment, α may be 0.95 and β may be 0.05, emphasizing environmental restoration fidelity over execution quality. However, in some embodiments, these weights may be dynamically adjusted or learned via model optimization.

The Total Action Score may be stored in a knowledge base and used in several ways. For example, high-scoring actions may be reused for similar future incidents, either directly or as training exemplars. Additionally, the scores may serve as a reward signal for reinforcement learning, such as through PPO or other algorithms. Reward tiers may be defined based on score ranges (e.g., Excellent, Good, Satisfactory), although such ranges may vary depending on operational context.

For example, the system may incorporate a reinforcement learning framework configured to improve the performance of LLMs used for generating automated incident remediation actions. The reinforcement learning loop may be implemented using a PPO algorithm or a functionally equivalent policy-gradient method, selected for its stability and sample efficiency in environments involving high-dimensional action spaces and delayed reward signals.

The PPO implementation may operate over a multi-stage training pipeline. Initially, the LLM may generate candidate remediation actions-such as shell scripts or command sequences-based on incident metadata (e.g., event name, event description, and affected system entity). Each generated action may be executed in a test or live environment, and the result of execution may be assessed using the scoring framework described previously. Specifically, a TAS may be computed using MELT similarity metrics and action execution metrics. This score may serve as a scalar reward signal used to guide policy updates within the PPO loop.

In one embodiment, the PPO training cycle may proceed through a sequence of operational phases designed to iteratively improve the LLM's policy for generating automated remediation actions. Initially, in a policy rollout phase, the current LLM policy may be used to generate a set of candidate actions in response to input incident data, such as event metadata or fault signatures. These actions are then executed in a test or production environment, and their performance is assessed using the TAS, which is recorded for each action.

Following this, the reward assignment phase maps each action to a scalar reward based on its corresponding TAS. In some implementations, this mapping may employ a tiered structure to discretize the reward signal, such as assigning a reward of 3 for TAS values greater than or equal to 90, a reward of 2 for TAS values between 80 and 89, a reward of 1 for TAS values between 70 and 79, and a penalty of −1 for scores below 70. These discrete tiers may facilitate early-stage convergence by providing clear reinforcement signals for highly effective actions.

Next, during the policy update phase, the PPO algorithm calculates a policy gradient using a clipped surrogate objective function. This approach is designed to limit the magnitude of the policy update at each iteration, thereby preventing the new policy from diverging excessively from the previous one. Such clipping may be particularly advantageous in dynamic or unstable environments, as it reduces the risk of oscillatory learning behavior and promotes more stable convergence.

Optionally, a value function update phase may be included to further enhance training stability. In this phase, a separate critic model or neural network may be trained in parallel to approximate the expected reward for a given input prompt and generated action. This value function may be used to reduce variance in the policy gradient estimation, contributing to more reliable and data-efficient learning across multiple training cycles.

The PPO algorithm may be implemented in a distributed fashion across multiple training environments, each corresponding to a different incident type or fault topology. This may enable the LLM to generalize across a variety of incident scenarios, while continuously refining its ability to generate high-quality remediation actions.

In some configurations, the scoring system may further support adaptive prompt generation, where low-scoring actions trigger updates to the input prompt fed into the LLM. This may facilitate iterative improvements by incorporating historical outcomes into future command generation via in-context learning. In some implementations, the system may apply adversarial testing or counterfactual analysis to improve the robustness of the scoring and training process. Accordingly, the disclosed scoring system enables a flexible, data-driven framework for evaluating automated remediation actions, allowing enterprises to balance correctness, reliability, and system impact while enabling continual improvement of AI-driven incident resolution pipelines.

In some implementations, the process may involve modifying a prompt used to generate the remediation script based on feedback from a prior execution. This modification may include applying in-context learning based on prior successful remediation scores. The ML component 154 may use this modified prompt to generate more effective remediation scripts in future incidents. In some implementations, the process may include injecting multiple faults and generating multiple remediation scripts. The system may then rank the generated remediation scripts based on their corresponding remediation scores. This ranking may facilitate selecting the most effective remediation strategy for a given incident type. In some implementations, the fault injection 170 may use a machine learning component trained to predict fault types based on historical incident data. This predictive capability may allow the system to focus on simulating the most relevant or likely incident scenarios, potentially improving the overall effectiveness of the incident remediation process.

The process illustrated in FIG. 1I may be designed with scalability in mind, allowing it to handle incident remediation across various scales of computing environments. In some implementations, the process may be capable of interfacing with multiple types of computing environments, including cloud-based infrastructures, on-premises systems, or hybrid environments.

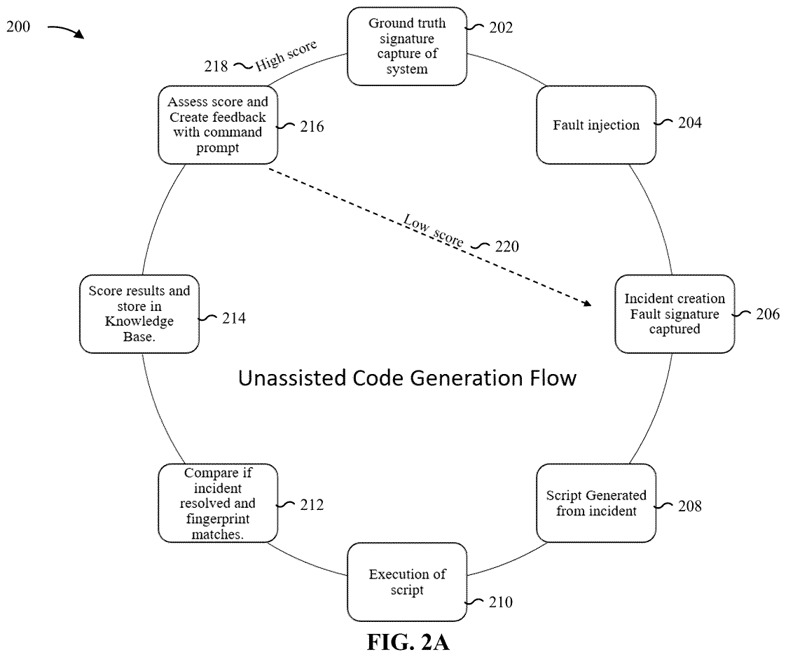

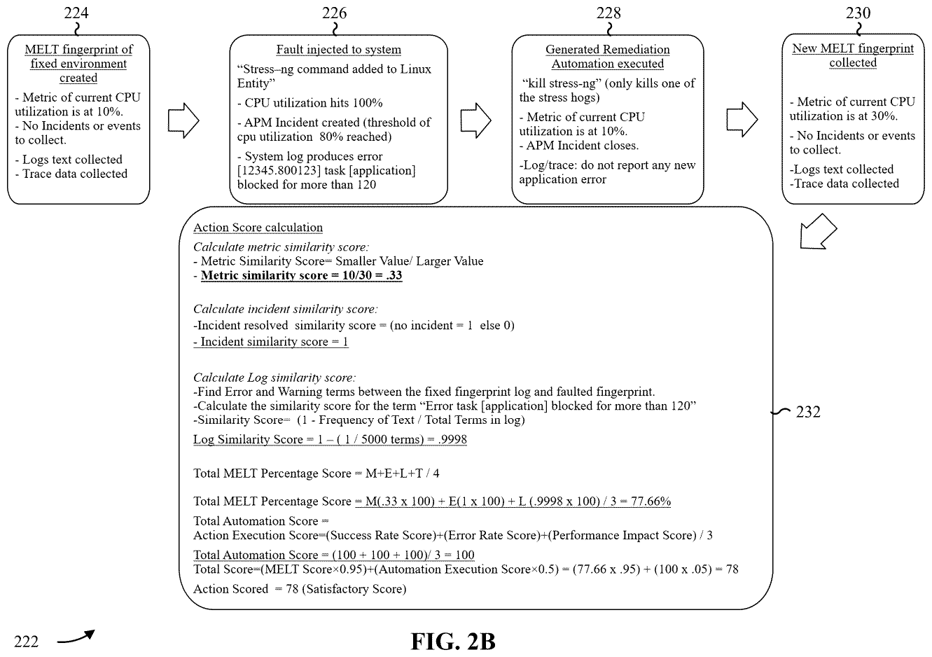

FIG. 2A illustrates a flowchart of an example 200 of a process for unassisted code generation associated with automated incident remediation. In some implementations, one or more aspects of the process may be performed by the remediation manager 112 of FIGS. 1A and 1H.

The process begins with operation 202, where a ground truth signature capture of the system is performed. In some implementations, this operation may be carried out by the MELT fingerprint engine 148 described in FIG. 1H. The ground truth signature may include baseline data indicative of metrics, events, logs, and traces associated with the computing environment in a fault-free state. This baseline data serves as a reference point for normal system operation and may be used for comparison in subsequent steps of the process.

Following the ground truth signature capture, the process moves to operation 204 for fault injection. In some implementations, this operation may be performed by the fault engine 150 described in FIG. 1H. The fault injection operation may be configured to introduce various types of faults or errors into the system to test its resilience and remediation capabilities. For example, the fault engine 150 may inject faults such as CPU throttling, network latency, or application errors to simulate real-world incident scenarios.

After fault injection, the process proceeds to operation 206, where incident creation occurs and a fault signature is captured. In some implementations, this operation may be carried out by the IEA 152 described in FIG. 1H. The fault signature may include a comprehensive set of metrics, events, logs, and traces that characterize the system's state during the simulated incident. This fault signature provides information for subsequent remediation steps.

The process then flows to operation 208, where a script is generated from the incident. In some implementations, this operation may be performed by the ML component 154 described in FIG. 1H. The ML component 154 may analyze the fault signature and other relevant data to generate a remediation script tailored to address the specific incident. This script generation process may leverage historical incident data, system documentation, and best practices for incident resolution.

Following script generation, the process continues to operation 210 for execution of the script. In some implementations, this operation may be carried out by an execution engine, such as the execution engine 162 described in FIG. 11. The execution of the remediation script may facilitate resolving the simulated incident and restoring the system to a healthy state.

After script execution, the process moves to operation 212, where a comparison is made to determine if the incident is resolved and if the fingerprint matches. In some implementations, this operation may involve obtaining remediation data corresponding to the execution of the remediation script. The remediation data may be compared to the original ground truth signature captured in operation 202 to assess the effectiveness of the remediation attempt.

The process then proceeds to operation 214, where score results are stored in a Knowledge Base. In some implementations, this operation may involve determining a remediation score based on the comparison performed in operation 212. The remediation score may be calculated based on various factors, such as the similarity between the post-remediation state and the ground truth signature, the resolution status of the incident, and other relevant metrics.

Following the storage of score results, the process moves to operation 216 to assess the score and create feedback with a command prompt. In some implementations, this operation may involve analyzing the remediation score and other relevant data to generate feedback for improving future remediation attempts. The feedback may be used to refine the script generation process or update the machine learning models used in the remediation system.

From operation 216, the process can take two paths based on the scoring results. A high score 218 leads back to operation 202 for another ground truth signature capture. This path may be taken when the remediation attempt is highly successful, and the system state closely matches the original fault-free state. In this case, the process may update its baseline data to reflect any legitimate changes in the system configuration or behavior.

In some implementations, a low score 220 leads to operation 206 to create another incident and capture the fault signature. This path may be taken when the remediation attempt is not sufficiently effective, requiring further iterations of the remediation process. By returning to the incident creation step, the system can refine its approach based on the feedback and lessons learned from the previous attempt.

The iterative nature of this process, as illustrated in FIG. 2A, may facilitate continuous improvement of the automated incident remediation system. By cycling through fault injection, script generation, execution, and evaluation, the system may adapt and refine its remediation strategies over time. This approach may lead to more effective and efficient incident resolution in complex computing environments.

In some implementations, the process illustrated in FIG. 2A may incorporate machine learning techniques to enhance its performance. For example, the script generation step (operation 208) may utilize reinforcement learning algorithms, such as PPO, to improve the quality of generated scripts based on past performance. The remediation scores stored in the Knowledge Base (operation 214) may serve as reward signals to update the policy network that influences script generation.

The process may be designed with scalability in mind, allowing it to handle incident remediation across various scales of computing environments. In some implementations, the process may be capable of interfacing with multiple types of computing environments, including cloud-based infrastructures, on-premises systems, or hybrid environments. This flexibility may enable the system to adapt to diverse IT landscapes and provide consistent remediation capabilities across different platforms.

FIG. 2B illustrates a flowchart for a MELT (Metrics, Events, Logs, Traces) fingerprint comparison and scoring process example 222. In some implementations, this process may be an extension or a more detailed view of certain operations described in FIG. 2A, particularly operations 212 and 214.

The process begins with operation 224, where a MELT fingerprint of a fixed environment is created. This operation may be similar to the ground truth signature capture (operation 202) in FIG. 2A. The MELT fingerprint may include metrics showing CPU utilization at 10%, no incidents or events to collect, and collection of logs text and trace data. This fingerprint serves as the baseline or reference point for subsequent comparisons.

The process flows to operation 226, where a fault is injected into the system. This operation may correspond to the fault injection step (operation 204) in FIG. 2A. In the example provided, a stress-ng command is added to the Linux Entity, causing CPU utilization to reach 100%. This fault injection triggers an APM Incident when CPU utilization exceeds 80%, and the system log produces an error indicating a blocked application task. This step simulates a real-world incident scenario, providing a context for testing the remediation process.

The process continues to operation 228, where generated remediation automation is executed. This operation may align with the script execution step (operation 210) in FIG. 2A. In the example, the automation executes a “kill stress-ng” command that terminates one of the stress processes. As a result, CPU utilization drops to 10%, the APM Incident closes, and no new application errors are reported in logs/trace. This step demonstrates the execution of a remediation action and its immediate effects on the system.

The process then moves to operation 230, where a new MELT fingerprint is collected. This operation may correspond to the comparison step (operation 212) in FIG. 2A. The new fingerprint shows CPU utilization at 30%, no incidents or events to collect, and includes collected logs text and trace data. This post-remediation fingerprint captures the system state after the remediation action has been applied.

The process concludes at operation 232 with action score calculation. This operation may align with the score storage step (operation 214) in FIG. 2A, but provides a more detailed view of the scoring process. The action score calculation includes computing various similarity scores between the fixed environment fingerprint and the post-remediation fingerprint.

In some implementations, the action score calculation may include determining a metric similarity score. For example, the CPU utilization metric may be compared between the baseline (10%) and the post-remediation state (30%). A similarity score may be calculated using a ratio of these values, providing a quantitative measure of how closely the system has returned to its baseline state.

The action score calculation may also include an incident similarity score. In the example provided, the incident has been resolved (APM Incident closed), which may result in a high similarity score for this component. This binary assessment (incident present or not) provides an indication of whether the primary goal of incident resolution has been achieved.

Furthermore, the action score calculation may incorporate log similarity scores. In some implementations, these scores may be computed using text analysis techniques such as term frequency-inverse document frequency (TF-IDF) algorithms. By comparing the log entries from the baseline and post-remediation states, the system may identify any remaining anomalies or confirm the successful resolution of the incident.

The comprehensive scoring approach illustrated in FIG. 2B may facilitate a nuanced evaluation of remediation effectiveness. By considering multiple factors such as metric similarity, incident resolution, and log analysis, the system may generate a more accurate and informative remediation score. This detailed scoring mechanism may provide valuable insights for refining future remediation strategies and improving the overall performance of the automated incident remediation system.

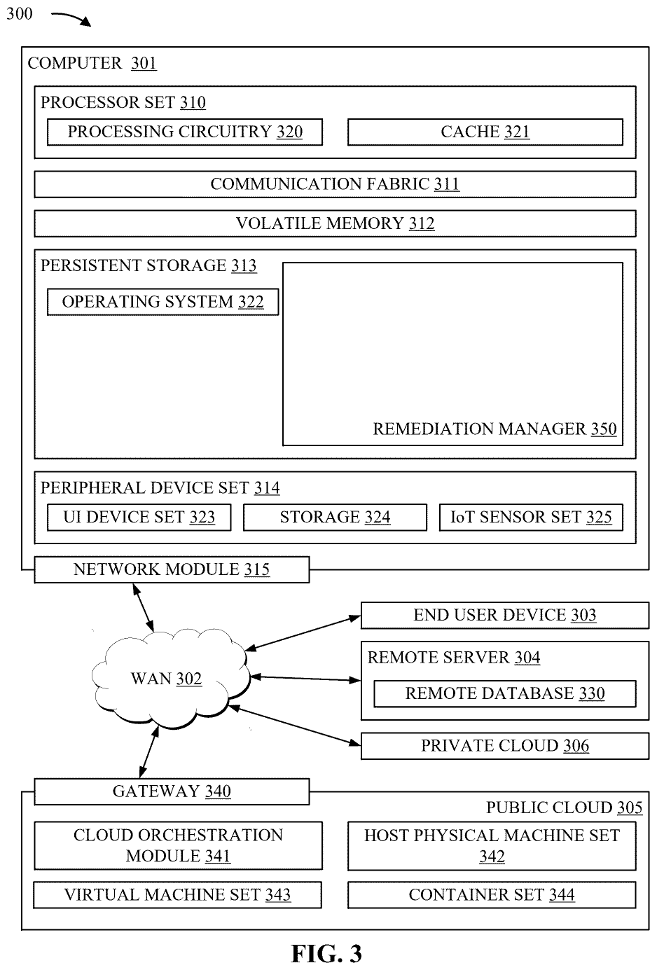

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 300 contains an example of an environment for the execution of at least some of the computer code involved in performing the inventive methods, such as the remediation manager, shown in block 350. In addition to block 350, the computing environment 300 includes, for example, a computer 301, a WAN 302, an end user device (EUD) 303, a remote server 304, a public cloud 305, and a private cloud 306. In this embodiment, the computer 301 includes a processor set 310 (including processing circuitry 320 and a cache 321), a communication fabric 311, a volatile memory 312, persistent storage 313 (including an operating system 322 and a block 350, as identified above), a peripheral device set 314 (including a user interface (UI) device set 323, storage 324, and an Internet of Things (IoT) sensor set 325), and a network module 315. The remote server 304 includes a remote database 330. The public cloud 305 includes a gateway 340, a cloud orchestration module 341, a host physical machine set 342, a virtual machine set 343, and a container set 344.

The computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 330. As is well understood in the art of computer technology, and depending upon the technology, performance of a computer-implemented method may be distributed among multiple computers and/or between multiple locations. On the other hand, in this presentation of the computing environment 300, detailed discussion is focused on a single computer, specifically the computer 301, to keep the presentation as simple as possible. The computer 301 may be located in a cloud, even though it is not shown in a cloud in FIG. 3. On the other hand, the computer 301 is not required to be in a cloud except to any extent as may be affirmatively indicated.

The processor set 310 includes one or more computer processors of any type now known or to be developed in the future. The processing circuitry 320 may be distributed over multiple packages, for example, multiple, coordinated integrated circuit chips. The processing circuitry 320 may implement multiple processor threads and/or multiple processor cores. The cache 321 is memory that is located in the processor chip package(s) and is typically used for data or code that should be available for rapid access by the threads or cores running on the processor set 310. Cache memories are typically organized into multiple levels depending upon relative proximity to the processing circuitry. Alternatively, some, or all, of the cache for the processor set may be located “off chip.” In some computing environments, the processor set 310 may be designed for working with qubits and performing quantum computing.

Computer readable program instructions are typically loaded onto the computer 301 to cause a series of operational steps to be performed by the processor set 310 of the computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 321 and the other storage media discussed below. The program instructions, and associated data, are accessed by the processor set 310 to control and direct performance of the inventive methods. In the computing environment 300, at least some of the instructions for performing the inventive methods may be stored in the block 350 in persistent storage 313.

The communication fabric 311 is the signal conduction path that allows the various components of the computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 312 is any type of volatile memory now known or to be developed in the future. Examples include dynamic type RAM or static type RAM. Typically, the volatile memory 312 is characterized by random access, but this is not required unless affirmatively indicated. In the computer 301, the volatile memory 312 is located in a single package and is internal to the computer 301, but, alternatively or additionally, the volatile memory 312 may be distributed over multiple packages and/or located externally with respect to the computer 301.

The persistent storage 313 is any form of non-volatile storage for computers that is now known or to be developed in the future. The non-volatility of this storage means that the stored data is maintained regardless of whether power is being supplied to the computer 301 and/or directly to the persistent storage 313. The persistent storage 313 may be a ROM, but typically at least a portion of the persistent storage allows writing of data, deletion of data and re-writing of data. Some familiar forms of persistent storage include magnetic disks and solid state storage devices. The operating system 322 may take several forms, such as various known proprietary operating systems or open source Portable Operating System Interface-type operating systems that employ a kernel. The code included in block 350 typically includes at least some of the computer code involved in performing the inventive methods.

The peripheral device set 314 includes the set of peripheral devices of the computer 301. Data communication connections between the peripheral devices and the other components of the computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 323 may include components such as a display screen, speaker, microphone, wearable devices (such as goggles and smart watches), keyboard, mouse, printer, touchpad, game controllers, and haptic devices. The storage 324 is external storage, such as an external hard drive, or insertable storage, such as an SD card. The storage 324 may be persistent and/or volatile. In some embodiments, the storage 324 may take the form of a quantum computing storage device for storing data in the form of qubits. In embodiments where the computer 301 is required to have a large amount of storage (for example, where the computer 301 locally stores and manages a large database) then this storage may be provided by peripheral storage devices designed for storing very large amounts of data, such as a storage area network (SAN) that is shared by multiple, geographically distributed computers. The IoT sensor set 325 is made up of sensors that can be used in Internet of Things applications. For example, one sensor may be a thermometer and another sensor may be a motion detector.

The network module 315 is the collection of computer software, hardware, and firmware that allows the computer 301 to communicate with other computers through the WAN 302. The network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 315 are performed on the same physical hardware device. In other embodiments (for example, embodiments that utilize software-defined networking (SDN)), the control functions and the forwarding functions of the network module 315 are performed on physically separate devices, such that the control functions manage several different network hardware devices. Computer readable program instructions for performing the inventive methods can typically be downloaded to the computer 301 from an external computer or external storage device through a network adapter card or network interface included in the network module 315.

The WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The EUD 303 is any computer system that is used and controlled by an end user (for example, a customer of an enterprise that operates the computer 301) and may take any of the forms discussed above in connection with the computer 301. The EUD 303 typically receives helpful and useful data from the operations of computer 301. For example, in a hypothetical case where the computer 301 is designed to provide a recommendation to an end user, this recommendation would typically be communicated from the network module 315 of the computer 301 through the WAN 302 to the EUD 303. In this way, the EUD 303 can display, or otherwise present, the recommendation to an end user. In some embodiments, the EUD 303 may be a client device, such as thin client, heavy client, mainframe computer, desktop computer and so on.

The remote server 304 is any computer system that serves at least some data and/or functionality to the computer 301. The remote server 304 may be controlled and used by the same entity that operates the computer 301. The remote server 304 represents the machine(s) that collect and store helpful and useful data for use by other computers, such as the computer 301. For example, in a hypothetical case where the computer 301 is designed and programmed to provide a recommendation based on historical data, then this historical data may be provided to the computer 301 from the remote database 330 of the remote server 304.

The public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 305 is performed by the computer hardware and/or software of the cloud orchestration module 341. The computing resources provided by the public cloud 305 are typically implemented by virtual computing environments that run on various computers making up the computers of the host physical machine set 342, which is the universe of physical computers in and/or available to the public cloud 305. The virtual computing environments (VCEs) typically take the form of virtual machines from the virtual machine set 343 and/or containers from the container set 344. It is understood that these VCEs may be stored as images and may be transferred among and between the various physical machine hosts, either as images or after instantiation of the VCE. The cloud orchestration module 341 manages the transfer and storage of images, deploys new instantiations of VCEs and manages active instantiations of VCE deployments. The gateway 340 is the collection of computer software, hardware, and firmware that allows the public cloud 305 to communicate through the WAN 302.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 306 is similar to the public cloud 305, except that the computing resources are only available for use by a single enterprise. While the private cloud 306 is depicted as being in communication with the WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 305 and the private cloud 306 are both part of a larger hybrid cloud.

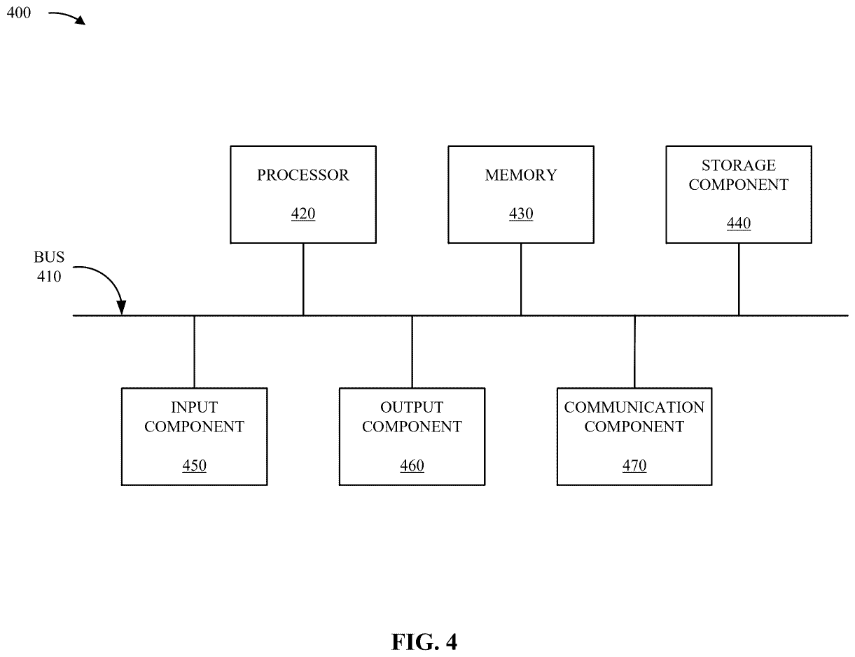

FIG. 4 is a diagram of example components of a device 400, which may implement one or more components of the computing environment 100. In some implementations, the device 400 may be, be similar to, include, or be included in the computer 301 shown in FIG. 3. The device 400 may be, be similar to, include, or be included in, an apparatus for performing one or more methods, processes, algorithms, operations, tasks, and/or techniques, as described herein. The device 400 may be, be similar to, include, or be included in, a computing device, a laptop, a workstation, a server device, or a personal computer, among other examples. As shown in FIG. 4, device 400 may include a bus 410 that interconnects various components or units, such as a processor 420, a memory 430, a storage component 440, an input component 450, an output component 460, and a communication component 470.

The processor 420 may be a central processing unit, such as a microprocessor, and may include single or multiple processors having single or multiple processing cores. The processor 420 may include another type of device, or multiple devices, configured for manipulating or processing information. For example, the processor 420 may include multiple processors interconnected in one or more manners, including hardwired or networked. The operations of the processor 420 may be distributed across multiple devices or units that can be coupled directly or across a local area or other suitable type of network. The processor 420 may include a cache, or cache memory, for local storage of operating data or instructions. The processor 420 is implemented in hardware, firmware, or a combination of hardware and software. In some implementations, the processor 420 includes one or more processors capable of being programmed to perform a function. In some implementations, the processor 420 may be, be similar to, include, or be included in processor set 310 shown in FIG. 3.

The memory 430 includes one or more memory components, which may each be volatile memory or non-volatile memory. The memory 430 may include non-transitory memory. The volatile memory can be RAM (e.g., a DRAM module, such as DDR SDRAM). The non-volatile memory of the memory 430 may be a disk drive, a solid state drive, flash memory, or phase-change memory. In some implementations, the memory 430 may be distributed across multiple devices. For example, the memory 430 may include network-based memory or memory in multiple clients or servers performing the operations of those multiple devices.

The memory 430 may include data for access by the processor 420. For example, the memory 430 may include executable instructions, application data, or an operating system, among other examples. The executable instructions may include one or more application programs, which may be loaded or copied, in whole or in part, from non-volatile memory to volatile memory to be executed by the processor 420. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 440 stores information and/or software related to the operation of the device 400. For example, the storage component 440 may include a hard disk drive, a magnetic disk drive, an optical disk drive, a solid state disk drive, a compact disc, a digital versatile disc, and/or another type of non-transitory computer-readable medium. The storage component 440 may be, be similar to, include, or be included in, the memory 430.

The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, and/or an actuator. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, and/or an antenna.

The device 400 may perform one or more processes described herein. For example, a non-transitory computer-readable medium (e.g., the memory 430 and/or the storage component 440) may store a set of instructions (e.g., one or more instructions, code, software code, and/or program code) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 3 and 4, such as a single processor or a combination of multiple different processors. Reference to “one or more processors” should be understood to refer to any one or more of the processors described in connection with FIGS. 3 and 4.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 3 and 4. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

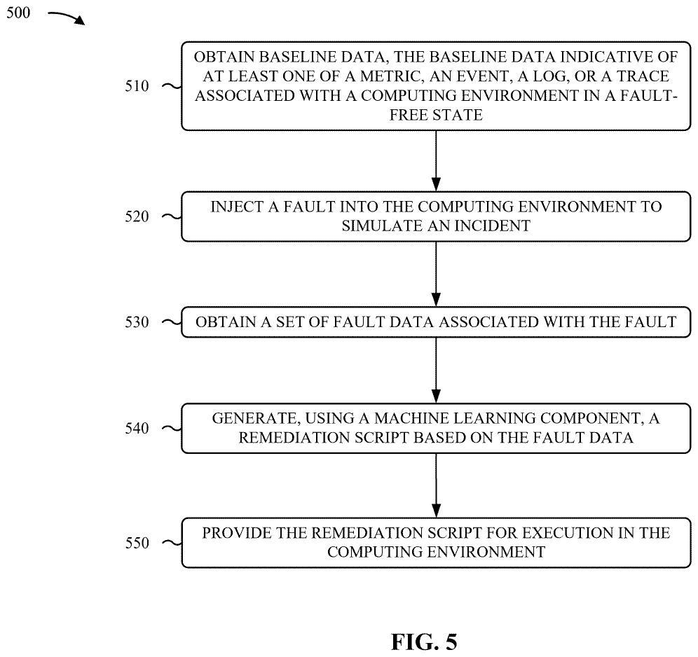

To further describe some implementations in greater detail, reference is next made to examples of techniques which may be performed by or using an AI system as described herein. FIG. 5 is a flowchart of an example of a technique 500 associated with automated incident remediation. The technique 500 can be executed using computing devices, such as the systems, hardware, and software described with respect to FIGS. 1A-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof.

For simplicity of explanation, the technique 500 is depicted and described herein as a series of steps or operations. However, the steps or operations of the technique 500 can occur in various orders and/or concurrently. Additionally, other steps or operations not presented and described herein may be used. Furthermore, not all illustrated steps or operations may be required to implement a technique in accordance with the disclosed subject matter.

At 510, the technique 500 may include obtaining baseline data indicative of at least one of a metric, an event, a log, or a trace associated with a computing environment in a fault-free state. In some implementations, this step may be performed by a MELT fingerprint engine, such as the MELT fingerprint engine 148 described in FIG. 1H. The baseline data may serve as a reference point for normal system operation. For example, the baseline data may include CPU utilization percentages, network traffic patterns, application response times, and system log entries during typical operational conditions.

At 520, the technique 500 may include injecting a fault into the computing environment to simulate an incident. In some implementations, this step may be performed by a fault engine, such as the fault engine 150 described in FIG. 1H. The fault injection may facilitate proactive testing and improvement of incident response capabilities. For example, a fault could involve artificially increasing CPU load, introducing network latency, or triggering application errors.

At 530, the technique 500 may include obtaining a set of fault data associated with the fault. In some implementations, this step may be performed by an IEA, such as the IEA 152 described in FIG. 1H. The fault data may encompass various aspects of the system's state during the incident, including metrics that deviate from baseline values, newly generated error logs, and changes in application behavior.

At 540, the technique 500 may include generating, using a machine learning component, a remediation script based on the fault data. In some implementations, this step may be performed by a machine learning component, such as the ML component 154 described in FIG. 1H. The machine learning component may be an LLM trained on historical incident data, system documentation, and best practices for incident resolution. The remediation script generation process may take into account the specific fault data collected, as well as contextual information about the affected systems and applications.

At 550, the technique 500 may include providing the remediation script for execution in the computing environment. In some implementations, this execution may be performed automatically, while in others, it may require human approval before application. The execution of the remediation script may facilitate resolving the simulated incident and restoring the system to a healthy state.

In some implementations, the technique 500 may further include obtaining remediation data corresponding to the execution of the remediation script. This remediation data may be compared to the original baseline data to determine the effectiveness of the remediation script. For example, a remediation score may be determined based on a similarity between the baseline data and the remediation data.

In some implementations, the remediation score may be determined based on a weighted combination of metric similarity, log similarity, event resolution status, and trace similarity. For example, the metric similarity score may be computed using a ratio between a value in the remediation data and a corresponding value in the baseline data. The incident similarity score may be assigned a first value if an incident is present in the remediation data and a second value if no incident is present. The log similarity score may be computed using a term frequency-inverse document frequency (TF-IDF) algorithm on text extracted from the baseline data and the remediation data.

In some implementations, the technique 500 may include modifying a prompt used to generate the remediation script based on feedback from a prior execution. This modification may include applying in-context learning based on prior successful remediation scores. The modified prompt may be used by the machine learning component to generate more effective remediation scripts in future incidents.

In some implementations, the technique 500 may include injecting multiple faults and generating multiple remediation scripts. The system may then rank the generated remediation scripts based on their corresponding remediation scores. This ranking may facilitate selecting the most effective remediation strategy for a given incident type.

In some implementations, the technique 500 may include training the machine learning component by applying a reinforcement learning algorithm using PPO. The remediation score may be used as a reward signal to update a policy network that influences remediation script generation. This approach may facilitate continuous improvement of the remediation script generation process over time.

In some implementations, the technique 500 may include selecting the fault using a machine learning component trained to predict fault types based on historical incident data. This predictive capability may allow the system to focus on simulating the most relevant or likely incident scenarios, potentially improving the overall effectiveness of the incident remediation process.

The computer-implemented method described herein improves the efficiency and effectiveness of incident remediation in computing environments by utilizing a proactive approach to fault simulation and automated script generation. Additionally, the method reduces the time and resources required for incident resolution by leveraging machine learning techniques to generate context-aware remediation scripts.

In embodiments, the method can include obtaining remediation data corresponding to the execution of the remediation script. This step has the technical effect of enabling the system to assess the effectiveness of the generated remediation script.

In embodiments, the method can include determining a remediation score based on a similarity between the baseline data and the remediation data. This scoring mechanism has the technical effect of quantifying the success of the remediation attempt, facilitating continuous improvement of the remediation process.

In embodiments, the remediation score can be determined based on a weighted combination of metric similarity, log similarity, event resolution status, and trace similarity. This comprehensive scoring approach has the technical effect of providing a more nuanced and accurate assessment of remediation effectiveness across multiple system aspects.

In embodiments, generating the remediation script can include generating the script based on incident metadata associated with the fault. This approach has the technical effect of producing more targeted and context-aware remediation scripts.

In embodiments, the incident metadata can comprise at least one of an event name, an event description, or an affected entity. This detailed metadata has the technical effect of enabling more precise fault diagnosis and script generation.

In embodiments, the method can include modifying a prompt used to generate the remediation script based on feedback from a prior execution. This feedback loop has the technical effect of improving the quality and relevance of generated scripts over time.

In embodiments, modifying the prompt can include applying in-context learning based on prior successful remediation scores. This learning mechanism has the technical effect of adapting the script generation process to historical successes, potentially improving future remediation attempts.

In embodiments, the method can include injecting at least one additional fault and generating at least one additional remediation script corresponding to the at least one additional fault. This multi-fault approach has the technical effect of simulating and preparing for more complex incident scenarios.

In embodiments, the method can include ranking a plurality of generated remediation scripts, including the remediation script, based on corresponding remediation scores. This ranking mechanism has the technical effect of identifying the most effective remediation strategies for different types of incidents.

The computer program product described herein improves the automation and efficiency of incident remediation processes in computing environments. Additionally, it enables more consistent and reliable incident response by leveraging machine learning techniques for script generation.

In embodiments, the operations can further include obtaining remediation data corresponding to the execution of a remediation script performed in the computing environment, determining a metric similarity score based on a comparison of metric values in the baseline data and the remediation data, determining an incident similarity score based on a presence or absence of an incident in the remediation data, determining at least one of a log similarity score or a trace similarity score based on a text similarity analysis between the baseline data and the remediation data, and determining a total remediation score based on a weighted combination of the metric similarity score, the incident similarity score, and at least one of the log similarity score or the trace similarity score. This comprehensive scoring system has the technical effect of providing a detailed and multi-faceted evaluation of remediation effectiveness. Additionally, it enables fine-grained analysis of different aspects of system recovery.

In embodiments, the metric similarity score can be computed using a ratio between a value in the remediation data and a corresponding value in the baseline data. This computation method has the technical effect of quantifying the degree of system recovery in terms of measurable metrics. Additionally, it provides a normalized measure for comparing different remediation attempts.

In embodiments, the incident similarity score can be assigned a first value if an incident is present in the remediation data and a second value if no incident is present. This binary scoring approach has the technical effect of clearly indicating whether the primary goal of incident resolution has been achieved. Additionally, it provides a simple and unambiguous measure of remediation success.

In embodiments, the log similarity score can be computed using a term frequency-inverse document frequency (TF-IDF) algorithm on text extracted from the baseline data and the remediation data. This text analysis technique has the technical effect of identifying significant changes in system logs before and after remediation. Additionally, it enables the detection of subtle issues that may not be captured by other metrics.

The computer system described herein improves the reliability and resilience of computing environments by implementing an intelligent, proactive incident remediation framework. Additionally, it reduces the need for manual intervention in system maintenance and troubleshooting processes.

In embodiments, the operations can further include determining a remediation score based on a comparison between the remediation data and reference data, and modifying, based on the remediation score, at least one input used by the machine learning component to generate a subsequent remediation script. This feedback loop has the technical effect of continuously improving the quality and effectiveness of generated remediation scripts. Additionally, it enables the system to adapt to changing system conditions and evolving incident patterns.

In embodiments, the operations can include training the machine learning component by applying a reinforcement learning algorithm using PPO, where the remediation score is used as a reward signal to update a policy network that influences remediation script generation. This advanced machine learning approach has the technical effect of optimizing the script generation process based on real-world outcomes. Additionally, it allows the system to learn complex remediation strategies that may not be obvious to human operators.

In embodiments, the operations can include selecting the fault using a machine learning component trained to predict fault types based on historical incident data. This predictive fault selection has the technical effect of focusing testing efforts on the most relevant and likely incident scenarios. Additionally, it improves the overall effectiveness of the incident remediation process by prioritizing high-impact or frequently occurring faults.

In embodiments, the operations can include generating the remediation script based on determining that a deviation score between the fault fingerprint and the baseline fingerprint satisfies a deviation criterion. This threshold-based script generation has the technical effect of ensuring that remediation actions are only triggered for significant deviations from normal system behavior. Additionally, it helps prevent unnecessary system interventions for minor or transient issues.

The method described herein enables a comprehensive approach to incident remediation by simulating faults, generating targeted remediation scripts, and assessing their effectiveness through remediation data analysis. The inclusion of remediation data collection provides valuable feedback for continuous improvement of the remediation process.

In some implementations, the method further includes determining a remediation score based on a similarity between the baseline data and the remediation data. This addition allows for quantitative evaluation of remediation effectiveness, facilitating data-driven improvements to the incident response system. The remediation score provides a concrete metric for assessing the success of automated remediation attempts, enabling more informed decision-making in incident management.

In some implementations, the method includes obtaining baseline data, injecting a fault, obtaining fault data, generating a remediation script using a machine learning component, providing the script for execution, and generating the remediation script based on incident metadata associated with the fault. This approach enhances the context-awareness of the remediation process by incorporating specific incident details into script generation. The use of incident metadata allows for more tailored and effective remediation strategies, potentially improving the success rate of automated incident resolution.

In some implementations, the incident metadata comprises at least one of an event name, an event description, or an affected entity. This detailed metadata enables more precise fault diagnosis and script generation, potentially leading to more accurate and efficient remediation actions. The inclusion of specific incident details allows the system to generate highly targeted remediation scripts that address the root cause of the incident more effectively.

In some implementations, the method further includes modifying a prompt used to generate the remediation script based on feedback from a prior execution. This feedback loop enables continuous refinement of the script generation process, potentially leading to increasingly effective remediation strategies over time. The ability to modify prompts based on prior executions allows the system to learn from past successes and failures, adapting its approach to better handle future incidents.

In some implementations, the computer program product includes operations for obtaining baseline data, injecting a fault, obtaining fault data, generating a remediation script using a machine learning component, providing the script for execution, obtaining remediation data, determining various similarity scores, and determining a total remediation score based on a weighted combination of these scores. This comprehensive approach to remediation assessment provides a nuanced evaluation of script effectiveness across multiple dimensions. The use of weighted scoring allows for a balanced consideration of different aspects of system recovery, potentially leading to more accurate overall assessment of remediation success.

In some implementations, the operations further include determining a metric similarity score computed using a ratio between a value in the remediation data and a corresponding value in the baseline data. This specific scoring method provides a quantitative measure of how closely the system has returned to its baseline state after remediation. The use of ratios allows for normalized comparisons across different metrics, enabling a more standardized assessment of recovery across various system parameters.

In some implementations, the operations also include determining an incident similarity score assigned a first value if an incident is present in the remediation data and a second value if no incident is present. This binary scoring approach provides a clear indication of whether the primary goal of incident resolution has been achieved. The simplicity of this score makes it easy to quickly assess the fundamental success of the remediation effort, which can be particularly useful in time-sensitive situations.

In some implementations, the operations further include determining a log similarity score computed using a term frequency-inverse document frequency (TF-IDF) algorithm on text extracted from the baseline data and the remediation data. This text analysis technique enables the detection of subtle changes in system logs that may not be captured by other metrics. The use of TF-IDF allows for the identification of significant terms or patterns in the logs, potentially revealing underlying issues or confirming successful remediation in ways that might not be apparent from numerical metrics alone.

In some implementations, the computer system includes operations for obtaining baseline data, injecting a fault, obtaining fault data, generating a remediation script using a machine learning component, providing the script for execution, determining a remediation score, and modifying at least one input used by the machine learning component to generate a subsequent remediation script based on the remediation score. This feedback-driven approach enables continuous improvement of the remediation process, potentially leading to more effective incident resolution over time. The ability to modify inputs based on remediation scores allows the system to adapt its script generation strategy, potentially improving its performance in handling diverse and evolving incident scenarios.

In one implementation, the automated incident remediation system effectively addresses a critical CPU utilization issue in a production environment. When the fault engine injects a simulated CPU throttling fault, causing utilization to spike to 100% on a specific node, the system immediately detects the deviation from the baseline MELT fingerprint. The machine learning component, leveraging historical incident data and system documentation, generates a remediation script designed to identify and terminate resource-intensive processes. Upon execution, the script successfully reduces CPU utilization to 30%, resolving the immediate incident. However, the system's sophisticated scoring mechanism, comparing the post-remediation state to the baseline fingerprint, determines that while the incident is resolved, the system has not fully returned to its optimal state. This triggers a refinement of the remediation strategy, where the machine learning component, using in-context learning based on the partial success, generates an improved script. The second iteration further optimizes resource allocation, bringing CPU utilization closer to the baseline 10%. This demonstrates the system's ability to not only resolve immediate incidents but also to continuously improve its remediation strategies through iterative learning and feedback incorporation.

In another scenario, the system showcases its capability to handle complex, multi-faceted incidents. The fault engine simulates a combination of network latency and application errors across a distributed microservices architecture. The MELT fingerprint engine captures comprehensive data across metrics, events, logs, and traces, providing a holistic view of the system's degraded state. The machine learning component, trained on a diverse set of historical incidents, generates a multi-step remediation script. This script sequentially addresses network configuration issues, resets affected services, and adjusts application parameters. The execution of this script is monitored in real-time, with the system continuously comparing the evolving state against both the fault fingerprint and the baseline fingerprint. This dynamic assessment allows for on-the-fly adjustments to the remediation process, ensuring that each step effectively contributes to the overall system recovery. The final remediation score, calculated using a weighted combination of metric similarities, log analyses, and trace comparisons, provides a nuanced evaluation of the remediation's success. This score is then used to update the machine learning model's policy network through Proximal Policy Optimization, enhancing its ability to generate more effective scripts for future, similar incidents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method, comprising:
obtaining baseline data, the baseline data indicative of at least one of a metric, an event, a log, or a trace associated with a computing environment in a fault-free state;
injecting a fault into the computing environment to simulate an incident;
obtaining a set of fault data associated with the fault;
generating, using a machine learning component, a remediation script based on the set of fault data; and
providing the remediation script for execution in the computing environment.

2. The computer-implemented method of claim 1, further comprising:
obtaining remediation data corresponding to the execution of the remediation script.

3. The computer-implemented method of claim 2, further comprising:
determining a remediation score based on a similarity between the baseline data and the remediation data.

4. The computer-implemented method of claim 3, wherein the remediation score is determined based on a weighted combination of metric similarity, log similarity, event resolution status, and trace similarity.

5. The computer-implemented method of claim 1, wherein generating the remediation script comprises:
generating the remediation script based on incident metadata associated with the fault.

6. The computer-implemented method of claim 5, wherein the incident metadata comprises at least one of an event name, an event description, or an affected entity.

7. The computer-implemented method of claim 1, further comprising:
modifying a prompt used to generate the remediation script based on feedback from a prior execution.

8. The computer-implemented method of claim 7, wherein modifying the prompt comprises applying in-context learning based on prior successful remediation scores.

9. The computer-implemented method of claim 1, further comprising:
injecting at least one additional fault; and
generating at least one additional remediation script corresponding to the at least one additional fault.

10. The computer-implemented method of claim 1, further comprising:
ranking a plurality of generated remediation scripts, including the remediation script, based on corresponding remediation scores.

11. A computer program product, comprising:
one or more non-transitory computer-readable storage media; and
program instructions stored on the one or more computer-readable storage media to perform operations, comprising:
obtaining baseline data, the baseline data indicative of at least one of a metric, an event, a log, or a trace associated with a computing environment in a fault-free state;
injecting a fault into the computing environment to simulate an incident;
obtaining a set of fault data associated with the fault;
generating, using a machine learning component, a remediation script based on the set of fault data; and
providing the remediation script for execution in the computing environment.

12. The computer program product of claim 11, the operations further comprising:
obtaining remediation data corresponding to the execution of a remediation script performed in the computing environment;
determining a metric similarity score based on a comparison of metric values in the baseline data and the remediation data;
determining an incident similarity score based on a presence or absence of an incident in the remediation data;
determining at least one of a log similarity score or a trace similarity score based on a text similarity analysis between the baseline data and the remediation data; and
determining a total remediation score based on a weighted combination of the metric similarity score, the incident similarity score, and at least one of the log similarity score or the trace similarity score.

13. The computer program product of claim 12, wherein the metric similarity score is computed using a ratio between a value in the remediation data and a corresponding value in the baseline data.

14. The computer program product of claim 12, wherein the incident similarity score is assigned a first value if an incident is present in the remediation data and a second value if no incident is present.

15. The computer program product of claim 12, wherein the log similarity score is computed using a term frequency-inverse document frequency (TF-IDF) algorithm on text extracted from the baseline data and the remediation data.

16. A computer system, comprising:
a processor set;
one or more computer-readable storage media; and
program instructions stored on the one or more computer-readable storage media to cause the processor set to perform operations comprising:
obtaining baseline data, the baseline data indicative of at least one of a metric, an event, a log, or a trace associated with a computing environment in a fault-free state;
injecting a fault into the computing environment to simulate an incident;
obtaining a set of fault data associated with the fault;
generating, using a machine learning component, a remediation script based on the set of fault data; and
providing the remediation script for execution in the computing environment.

17. The computer system of claim 16, the operations further comprising:
determining a remediation score based on a comparison between remediation data and reference data; and
modifying, based on the remediation score, at least one input used by the machine learning component to generate a subsequent remediation script.

18. The computer system of claim 17, the operations further comprising:
training the machine learning component by applying a reinforcement learning algorithm using Proximal Policy Optimization (PPO), wherein the remediation score is used as a reward signal to update a policy network that influences remediation script generation.

19. The computer system of claim 16, the operations further comprising:
selecting the fault using a machine learning component trained to predict fault types based on historical incident data.

20. The computer system of claim 16, the operations further comprising:
generating the remediation script based on determining that a deviation score between a fault fingerprint and a baseline fingerprint satisfies a deviation criterion.
